(19) United States
(12) Patent Application Publication
(10) Pub. No.: US 2019/0007196 A1
(43) Pub. Date: Jan. 3, 2019

(54) METHOD AND SYSTEM FOR PRIVACY PRESERVING COMPUTATION IN CLOUD USING FULLY HOMOMORPHIC ENCRYPTION

(71) Applicant: QATAR UNIVERSITY, Doha (QA)

(72) Inventors: Qutaibah M. MALLUHI, Doha (QA); Yongge WANG, Matthews, NC (US)

(21) Appl. No.: 15/635,891

(22) Filed: Jun. 28, 2017

(51) Int. Cl. H04L 9/00; H04L 9/08; H04L 29/06; H04L 9/30; H04L 9/14

(52) U.S. Cl. CPC H04L 9/008; H04L 9/0869; H04L 9/14; H04L 9/302; H04L 63/0428

(57) ABSTRACT

Certain embodiments relate to noise-free fully homomorphic symmetric key encryption (FHE) schemes without bootstrapping based on octonion algebra over finite fields and finite rings, this disclosure introduces. The FHE schemes may be secure in the ciphertext-only security model. Certain embodiments also relate to a method for a client to carry out privacy preserving computation in a server where the client upload her encrypted data and encrypted program to the server. The server may run the encrypted program on the encrypted data and return encrypted output to the client. The client may decrypt the encrypted output to get the actual output.

### FIELD OF THE INVENTION

Certain embodiments may generally relate to encryption. More specifically, certain embodiments of the present invention generally relate to data protection schemes in which an encrypted data and software processing system may provide data privacy protection using fully homomorphic encryption schemes.

### BACKGROUND OF THE INVENTION

Cloud computing techniques have become pervasive, and users have begun to store their private encrypted data in cloud services. In order to take full advantage of the cloud computing paradigm, it is important to design efficient techniques to protect client data privacy in the cloud. From a first look, encryption at rest seems to be a feasible solution to address these challenges. But a truly optimal solution is still far from reach since encryption has not been a good or an acceptable solution for cloud data storage. If encryption at rest is the only solution, then the functionality of cloud computing may be limited to encrypt data at the user's location, transmit encrypted data to the cloud, and then bringing the data back to the user's location for decryption before being used locally. Indeed, in many scenarios, it may be less expensive to store data locally than in the cloud. Thus, using the cloud for data storage without the capability of processing these data remotely may not be an economic approach.

With an increased dependence on cyber space and wider adoption of the cloud computing paradigm, data privacy and security are becoming increasingly important. There is a genuine need in the cloud services market for appropriate techniques to protect client data privacy. As mentioned above, encryption may be one of the major techniques that could be used to achieve this goal. However, data encryption alone is insufficient for secure cloud computation environments as it transforms the cloud into a dumb data vault that is unable to process or query the data it has. Therefore efficient methods for carrying out computation over encrypted data are required and will be very valuable.

Considering the state of the art, fully homomorphic encryption (FHE) and garbled circuits are naturally used to process encrypted data without leaking any information about the data. However, existing FHE schemes are often impractical because they are extremely inefficient for processing large amounts of data in the cloud. On the other hand, garbled circuits may be more efficient but they are one-time programs and cannot be reused.

A natural solution may be to use garbled computing techniques such as garbled circuits or fully homomorphic encryption schemes. That is, an adversary observing the computations of a garbled computation learns nothing about what it is doing, what data it is operating on (whether inputs or intermediate values), and the outputs it is producing. The garbled circuit concept has been introduced, which allows computing a function f on an input x without leaking any information about the input x or the circuit used for the computation off f (x). Since then, garbled circuit based protocols have been used in numerous places and it has become one of the fundamental components of secure multi-party computation protocols. However, there are at least two disadvantages in this approach. Firstly, the garbled circuit is not reusable. Secondly, using a garbled circuit to evaluate an algorithm on encrypted data takes the worst-case runtime of the algorithm on all inputs of the same length since Turing machines are simulated by circuits via unrolling loops to their worst-case runtime, and via considering all branches of a computation.

It has also been proposed that the first fully FHE design use a somewhat-homomorphic encryption scheme and then use bootstrapping techniques to convert it to a fully homomorphic encryption scheme. Since in the initial FHE design, the performance of FHE scheme has improved, it is still impractical for cloud garbled computation applications. For example, the most efficient implementation takes approximately 4 minutes to carry out a garbled AES encryption on a 128 bit input.

The main performance bottleneck for the above approach is the “noise” reduction process, since the homomorphic operations increase the noise in ciphertexts. After a homomorphic operation (e.g., a circuit gate evaluation) is performed on the cipher-texts, a bootstrapping technique is used to refresh the ciphertexts by homomorphically computing the decryption function and bringing the noise of the ciphertexts back to acceptable levels. The bootstrapping operation accounts for the major performance cost in FHE implementations. Thus, the performance of FHE schemes may be significantly improved if one could design noise-free FHE schemes.

There is a need, therefore for developing techniques for processing encrypted data at the cloud without downloading them to the local site. There is also a need to introduce noise-free homomorphic symmetric key encryption schemes, and design efficient fully FHE schemes without bootstrapping that are secure in the weak ciphertext-only security model.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### SUMMARY OF THE INVENTION

One embodiment may be directed to a method that may include generating a secret key. According to an embodiment, generating the secret key may include selecting a number according to a security parameter, wherein the number is a product of two prime numbers. Generating the secret key may also include selecting an isotropic subspace from a tuple of eight numbers smaller than the number selected according to the security parameter. In an embodiment, the isotropic substance may be closed under octonion multiplications. Further, generating the secret key may include selecting a random automorphism from a collection of automorphisms and a random invertible 8×8 matrix. In an embodiment, the random invertible 8×8 matrix may be selected from a collection of matrices whose elements are smaller than the number selected according to the security parameter. Generating the secret key may also include setting a private key as a combination of the isotropic subspace, the random automorphism, and the random invertible 8×8 matrix.

In an embodiment, the method may further include encrypting data with the secret key. Encrypting the data, according to certain embodiments, may include selecting a random number from a collection of numbers smaller than the number selected according to the security parameter. Encrypting the data may also include selecting a random point, wherein the random point is an element of the isotropic subspace. Encrypting the data may further include adding the random point to an octonion (0,m,0,0,0,0,0,0), wherein m is the data to be encrypted to obtain an octonion m₁. In addition, encrypting the data may include using the random automorphism to map the octonion m₁ to another octonion m′. Further, encrypting the data may include calculating an associate matrix A_{m′}¹ for the octonion m′. In addition, encrypting the data may include obtaining the encrypted data by multiplying together an inverse of the random invertible 8×8 matrix, the random invertible 8×8 matrix, and A_{m′}¹.

According to certain embodiments, the method may further include decrypting the encrypted data. In an embodiment, decrypting the encrypted data may include multiplying together a first row of a matrix obtained by multiplying the random invertible 8×8 matrix, the encrypted data, and the inverse of the random invertible 8×8 matrix, with an inverse of the random automorphism.

According to certain embodiments, the method may also include uploading the encrypted data to a server. In an embodiment, encrypting the data may include encrypting an input. The method may also include sending the encrypted input to the server. In another embodiment, the server may be configured to run a public software on the encrypted input and the encrypted data, and obtain an encrypted output. According to another embodiment, the method may also include receiving the encrypted output from the server, and decrypting the encrypted output by multiplying together a first row of a matrix obtained by multiplying the random invertible 8×8 matrix, the encrypted data, and the inverse of the random invertible 8×8 matrix, with an inverse of the random automorphism.

In certain embodiments, the encryption of data may include encrypting a program. According to another embodiment, the method may include uploading the encrypted data and the encrypted program to a server. In an embodiment, the encrypting data may include encrypting an input. According to another embodiment, the method may include sending the encrypted input to the server. In an embodiment, the server may be configured to run the encrypted program on the encrypted input and the encrypted data, and the server may also be configured to obtain an encrypted output. According to another embodiment, the method may include receiving the encrypted output from the server, and decrypting the encrypted output by multiplying together a first row of a matrix obtained by multiplying the random invertible 8×8 matrix, the encrypted data, and the inverse of the random invertible 8×8 matrix, with an inverse of the random automorphism.

Another embodiment may be directed to an apparatus. The apparatus may include at least one memory including computer program code, and at least one processor. The at least one memory and the computer program code may be configured, with the at least one processor, to cause the apparatus at least to generate a secret key. According to an embodiment, generating the secret key may include selecting a number according to a security parameter, wherein the number is a product of two prime numbers. Generating the secret key may also include selecting an isotropic subspace from a tuple of eight numbers smaller than the number selected according to the security parameter. In an embodiment, the isotropic substance may be closed under octonion multiplications. Further, generating the secret key may include selecting a random automorphism from a collection of automorphisms and a random invertible 8×8 matrix. In an embodiment, the random invertible 8×8 matrix may be selected from a collection of matrices whose elements are smaller than the number selected according to the security parameter. Generating the secret key may also include setting a private key as a combination of the isotropic subspace, the random automorphism, and the random invertible 8×8 matrix.

The at least one memory and the computer program code may be configured, with the at least one processor, to cause the apparatus at least to encrypt data with the secret key. Encrypting the data, according to certain embodiments, may include selecting a random number from a collection of numbers smaller than the number selected according to the security parameter. Encrypting the data may also include selecting a random point, wherein the random point is an element of the isotropic subspace. Encrypting the data may further include adding the random point to an octonion (0,m,0,0,0,0,0,0), wherein m is the data to be encrypted to obtain an octonion m₁. In addition, encrypting the data may include using the random automorphism to map the octonion m₁ to another octonion m′. Further, encrypting the data may include calculating an associate matrix A_{m′}¹ for the octonion m′. In addition, encrypting the data may include obtaining the encrypted data by multiplying together an inverse of the random invertible 8×8 matrix, the random invertible 8×8 matrix, and A_{m′}¹.

The at least one memory and the computer program code may be configured, with the at least one processor, to cause the apparatus at least to decrypt the encrypted data. In an embodiment, decrypting the encrypted data may include multiplying together a first row of a matrix obtained by multiplying the random invertible 8×8 matrix, the encrypted data, and the inverse of the random invertible 8×8 matrix, with an inverse of the random automorphism.

The at least one memory and the computer program code may be configured, with the at least one processor, to cause the apparatus at least to upload the encrypted data to a server. In an embodiment, encrypting the data may include encrypting an input. In an embodiment, the at least one memory and the computer program code may also be configured, with the at least one processor, to cause the apparatus at least to send the encrypted input to the server. In another embodiment, the server may be configured to run a public software on the encrypted input and the encrypted data, and obtain an encrypted output. In another embodiment, the at least one memory and the computer program code may further be configured, with the at least one processor, to cause the apparatus at least to receive the encrypted output from the server, and decrypt the encrypted output by multiplying together a first row of a matrix obtained by multiplying the random invertible 8×8 matrix, the encrypted data, and the inverse of the random invertible 8×8 matrix, with an inverse of the random automorphism.

In certain embodiments, the encryption of the data may include encrypting a program. In another embodiment, the at least one memory and the computer program code may further be configured, with the at least one processor, to cause the apparatus at least to upload the encrypted data and the encrypted program to a server. According to an embodiment, the encrypting the data may include encrypting an input. In another embodiment, the at least one memory and the computer program code may further be configured, with the at least one processor, to cause the apparatus at least to send the encrypted input to a server. According to an embodiment, the server may be configured to run the encrypted program on the encrypted input and the encrypted data, and the server may be configured to obtain an encrypted output. In another embodiment, the at least one memory and the computer program code may further be configured, with the at least one processor, to cause the apparatus at least to receive the encrypted output from the server, and decrypt the encrypted output by multiplying together a first row of a matrix obtained by multiplying the random invertible 8×8 matrix, the encrypted data, and the inverse of the random invertible 8×8 matrix, with an inverse of the random automorphism.

Another embodiment may be directed to a computer program, embodied on a non-transitory computer readable medium, the computer program, when executed by a processor, may cause the processor to generate a secret key. According to an embodiment, generating the secret key may include selecting a number according to a security parameter, wherein the number is a product of two prime numbers. Generating the secret key may also include selecting an isotropic subspace from a tuple of eight numbers smaller than the number selected according to the security parameter. In an embodiment, the isotropic substance may be closed under octonion multiplications. Further, generating the secret key may include selecting a random automorphism from a collection of automorphisms and a random invertible 8×8 matrix. In an embodiment, the random invertible 8×8 matrix may be selected from a collection of matrices whose elements are smaller than the number selected according to the security parameter. Generating the secret key may also include setting a private key as a combination of the isotropic subspace, the random automorphism, and the random invertible 8×8 matrix.

The computer program, when executed by a processor, may further cause the processor to encrypt data with the secret key. Encrypting the data, according to certain embodiments, may include selecting a random number from a collection of numbers smaller than the number selected according to the security parameter. Encrypting the data may also include selecting a random point, wherein the random point is an element of the isotropic subspace. Encrypting the data may further include adding the random point to an octonion (0,m,0,0,0,0,0,0), wherein m is the data to be encrypted to obtain an octonion m₁. In addition, encrypting the data may include using the random automorphism to map the octonion m₁ to another octonion m′. Further, encrypting the data may include calculating an associate matrix A_{m′}¹ for the octonion m′. In addition, encrypting the data may include obtaining the encrypted data by multiplying together an inverse of the random invertible 8×8 matrix, the random invertible 8×8 matrix, and A_{m′}¹.

The computer program, when executed by a processor, may also cause the processor to decrypt the encrypted data. In an embodiment, the decrypting the encrypted data may include multiplying together a first row of a matrix obtained by multiplying the random invertible 8×8 matrix, the encrypted data, and the inverse of the random invertible 8×8 matrix, with an inverse of the random automorphism.

The computer program, when executed by a processor, may also cause the processor to upload the encrypted data to a server. In an embodiment, the encrypting the data may include encrypting an input. According to another embodiment, the computer program, when executed by a processor, may also cause the processor to send the encrypted input to the server. In an embodiment, the server may be configured to run a public software on the encrypted input and the encrypted data, and obtain an encrypted output. In another embodiment, the computer program, when executed by a processor, may also cause the processor to receive the encrypted output from the server, and decrypt the encrypted output by multiplying together a first row of a matrix obtained by multiplying the random invertible 8×8 matrix, the encrypted data, and the inverse of the random invertible 8×8 matrix, with an inverse of the random automorphism.

In an embodiment, the encrypting data may include encrypting a program. According to another embodiment, the computer program, when executed by a processor, may also cause the processor to upload the encrypted data and the encrypted program to a server. In an embodiment, the encrypting data may include encrypting an input. According to another embodiment, the computer program, when executed by a processor, may also cause the processor to send the encrypted input to a server. In certain embodiments, the server may be configured to run the encrypted program on the encrypted input and the encrypted data, and may be configured to obtain an encrypted output. According to certain embodiments, the computer program, when executed by a processor, may also cause the processor to receive the encrypted output from the server, and decrypt the encrypted output by multiplying together a first row of a matrix obtained by multiplying the random invertible 8×8 matrix, the encrypted data, and the inverse of the random invertible 8×8 matrix, with an inverse of the random automorphism.

This invention discloses a noise-free fully homomorphic symmetric key encryption (FHE) schemes without bootstrapping based on octonion algebra over finite fields and finite rings, this disclosure introduces. The proposed FHE schemes are secure in the ciphertext-only security model. The invention further discloses a method for client to carry out privacy preserving computation in a server where the client upload her encrypted data and encrypted program to the server. The server runs the encrypted program on the encrypted data and returns encrypted output to the client. The client decrypted the encrypted output to get the actual output.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 illustrates a flow diagram according to certain embodiments.

FIG. 2 illustrates another flow diagram according to certain embodiments.

FIG. 3 illustrates a further flow diagram according to certain embodiments.

FIG. 4 illustrates yet another flow diagram according to certain embodiments.

FIG. 5 illustrates another flow diagram according to certain embodiments for OctoM encryption and decryption processes.

FIG. 6 illustrates a further flow diagram according to certain embodiments for JordanM encryption and decryption processes.

FIG. 7 illustrates another flow diagram according to certain embodiments.

FIG. 8 illustrates a system according to certain embodiments.

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

### DETAILED DESCRIPTION

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention.

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

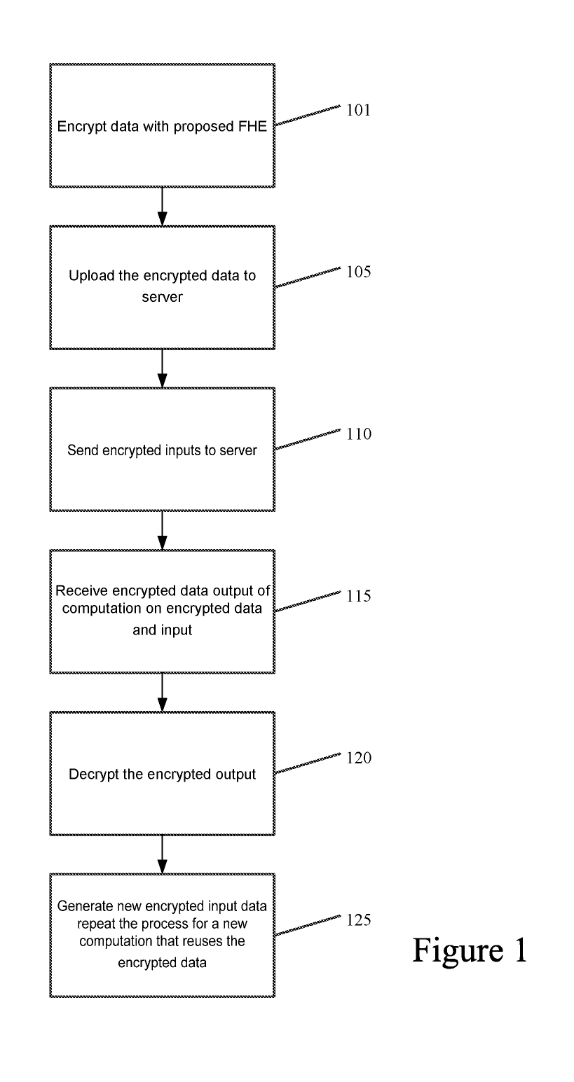

Certain embodiments are described herein for using various tools and procedures used by a software application to generate personalized videos in an automated fashion. The examples described herein are for illustrative purposes only. As will be appreciated by one skilled in the art, certain embodiments described herein, including, for example, but not limited to, those shown in FIGS. 1-8 embodied as a system, apparatus, method, or computer program product. Accordingly, certain embodiments may take the form of an entirely software embodiment or an embodiment combining software and hardware aspects. Software may include but is not limited to firmware, resident software, microcode, etc. Furthermore, other embodiments can take the form of a computer program product accessible from a computer-usable or computer-readable medium providing program code for use by or in connection with a computer or any instruction execution system.

Any combination of one or more computer usable or computer readable medium(s) may be utilized. For the purposes of this description, a computer-usable or computer readable medium can be any apparatus that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may independently be any suitable storage device, such as a non-transitory computer-readable medium. Suitable types of memory may include, but not limited to: a portable computer diskette; a hard disk drive (HDD), a random access memory (RAM), a read-only memory (ROM); an erasable programmable read-only memory (EPROM or Flash memory); a portable compact disc read-only memory (CDROM); and/or an optical storage device.

The memory may be combined on a single integrated circuit as a processor, or may be separate therefrom. Furthermore, the computer program instructions stored in the memory may be processed by the processor can be any suitable form of computer program code, for example, a compiled or interpreted computer program written in any suitable programming language. The memory or data storage entity is typically internal, but may also be external or a combination thereof, such as in the case when additional memory capacity is obtained from a service provider. The memory may also be fixed or removable.

The computer usable program code (software) may be transmitted using any appropriate transmission media via any conventional network. Computer program code, when executed in hardware, for carrying out operations of certain embodiments may be written in any combination of one or more programming languages, including, but not limited to, an object oriented programming language such as Java, Smalltalk, C++, C# or the like and conventional procedural programming languages, such as the “C” programming language or similar programming languages. Alternatively, certain embodiments may be performed entirely in hardware.

Depending upon the specific embodiment, the program code may be executed entirely on a user's device, partly on the user's device, as a stand-alone software package, partly on the user's device and partly on a remote computer, or entirely on the remote computer or server. In the latter scenario, the remote computer may be connected to the user's device through any type of conventional network. This may include, for example, a local area network (LAN) or a wide area network (WAN), Bluetooth, Wi-Fi, satellite, or cellular network, or the connection may be made to an external computer (for example, through the Internet using an Internet Service Provider).

According to certain embodiments, it is possible to use quaternion/octonion/Jordan algebra based coding techniques to introduce noise-free fully homomorphic symmetric key encryption schemes. The FHE schemes in certain embodiments may be secure in the weak ciphertext-only security model with the assumption that it is computationally infeasible to solve multivariate quadratic equation systems and it is computationally infeasible to solve univariate high degree polynomial equation systems in the underlying rings [symbol] _{q}. The hardness assumption for the security is reasonable for large enough [symbol] _{q} (e.g., [symbol] _{q}|≥2¹⁰⁰⁰) since it is known that finding square roots modulo a composite number is equivalent to factoring. The weak ciphertext-only security model for FHE is sufficient for garbled cloud computation applications (e.g., outsourcing of private algorithm implementations).

Linearly Decryptable Encryption Schemes

Works have been done to analyze the security and performance of FHE schemes. For example, the relationship between decryption circuit complexity and FHE scheme security has been investigated. In particular, it has been shown that if a scheme can homomorphically evaluate the majority function then its decryption cannot be weakly-learnable. A corollary of this result is that linearly decryptable FHE schemes cannot be secure in the CPA (chosen plaintext attacks) security model. According to certain embodiments, it may be shown that linearly decryptable FHE schemes cannot be secure even in the ciphertext-only security model. By relaxing the definition of the ciphertext-only attacks to the weak ciphertext-only attacks, according to certain embodiments, it is possible to design efficient secure FHE schemes with linear decryption circuits.

In certain embodiments, an encryption scheme may be linearly decryptable if the decryption circuit can be described as an inner product calculation. In the following, the Inner Product Encryption Scheme IPE=(IPE.Setup, IPE.Enc, IPE.Dec) is defined over finite rings [symbol] _{q}. The definition remains the same for the IPE scheme over finite fields [symbol] _{q}. In certain embodiments, the Inner Product Encryption Scheme IPE is different from various Inner Product Encryption Schemes used in the construction of Attribute Based Encryption (ABE) schemes in conventional literature.

In the Setup IPE.Setup(nκ), for a given security parameter κ and the dimension n≥3, choose a finite ring [symbol] _{q} and a random k=[k₀, . . . , kₙ₋₁] ∈ [symbol] *_{q} for at least one i<n. Further k may represent the private key. In the Encryption IPE.Enc, for a message m ∈ [symbol] _{q}, select a random c ∈ [symbol] _{q}ⁿ such that m=ck^{T} where ck^{T} is the inner product of c and k. Further, IPE.Enc (k, m)=c. In the Decryption IPE.Dec, for a ciphertext c, let m=IPE.Dec (k, c)=kc^{T}.

The definition of ciphertext-only security for an encryption scheme is closely related to the perfect secrecy definition for one-time pad encryption schemes. The commonly used security definition for one-time pad encryption scheme includes indistinguishability based IND-onetime and simulation based SIM-onetime security. In certain embodiments, the indistinguishability based security definition for ciphertext-only security (COA) may be used.

According to certain embodiments, the following definition and theorem may be provided:
Definition 1. (COA model) Let xx=(KeySetup, Enc, Dec) be a symmetric key encryption scheme over a message space M for a pair of probabilistic polynomial time (PTT) algorithms A=(A₀, A₁), define the following experiments:
   A₀ generates the secrete key by running key←xx.KeySetup(κ)where κ is the security parameter.
   A₀ chooses t messages p₀, . . . , p_{t-I} according to the distribution of M and outputs t ciphertexts Cₚ₀, . . . , C_{pt-I} by funning Cₚᵢ=xx.Enc (key, pᵢ).
   A_{I} selects 2 messages m₀, m₁ ∈ M and gives them to A₀.
   A₀ selects a random bit b ∈ {0, 1} and outputs C_{mb}=xx.Enc (key, m_{b}).
   A_{I} outputs a bit b′.
The output of the above experiment may be defined to be 1 if b′−b, and 0 otherwise. If the output is 1, then it is written COA^{(A}^{₀}^{,A}^{₁}⁾(κ)=1, and in this case, it is said that A₁ succeeded. The encryption scheme xx is said to be (t,ε)-secure in the ciphertext-only attack (COA) security model for ε=negl(κ) if for all PPT algorithms A=(A₀, A₁), we have

$$Prob = [ {COA}^{( {A}_{0} , {A}_{1} )} ( κ ) = 1 ] \leq \frac{1}{2} + ɛ .$$

According to other embodiments, the following theorem shows that an IPE encryption scheme cannot be fully homomorphic and secure in the ciphertext-only security model at the same time:
Theorem 1. Let xx=(KeySetup, Enc, Dec) be a fully homomorphic symmetric key encryption scheme over [symbol] _{q} such that the decryption process xx.Dec is equivalent to IPE.Dec of dimension n. Then xx is not secure in the ciphertext-only security model.
Proof Let k ∈ [symbol] _{q}ⁿ be the private key and xx.Dec(c)=kc^{T} for ciphertexts c ∈ [symbol] _{q}ⁿ. Without loss of generality, it may be assumed that the messages selected by the PPT algorithm A₁ during the experiment is m₀=0 and m₁=1. Let c_{b} ∈ [symbol] _{q}ⁿ be the ciphertext output by the algorithm A₀ during the experiment where b=0, 1.

According to certain embodiments, by using the multiplicative homomorphism property of xx, the algorithm A₁ can calculate ciphertexts c_{b,i}ε [symbol] _{q}ⁿ of bⁱ=b for i≥1. It is straightforward that for d−n+1 the ciphertexts c_{b,i}, . . . , c_{b,d} are linearly dependent. In other words, there exists a₁, . . . , a_{d} ∈ [symbol] _{q} such that a₁c_{b,1}+a₂c_{b,2}+ . . . +a_{d}c_{b,d}=0. This implies that

a₁b+a₂b²+ . . . +a_{d}b^{d}=0 (1)

If a₁+ . . . +a_{d}=0, then algorithm A₁ may output b′=1. Otherwise, it may output b′=0. Further, the algorithm A₁ may repeat the above process for ciphertexts c_{b,i+1}, . . . , c_{b,i+d} with different i>1 to get more accurate prediction b′ of the value b. Thus, it can be shown that b′=b with a non-negligible probability. The theorem is proved.

In certain embodiments, after proving Theorem 1, it may be possible to design a linearly decryptable FHE scheme that is secure in some relaxed security model. For instance, according to certain embodiments, it may be possible to design linearly decryptable FHE schemes that are secure in the following weak ciphertext-only security model (wCoA).
Definition 2. (wCOA model) Let xx=(KeySetup, Enc, Dec) be a symmetric key encryption scheme over a message space M For a pair of PPT algorithms A=(A₀, A₁), define the following experiments:
   A₀ generates the secrete key by running key←xx.KeySetup(κ) where κ is the security parameter.
   A₀ chooses t messages p₀, . . . , p_{t-I} according to the distribution of M and outputs t ciphertexts Cₚ₀, . . . , C_{pt-I} by running Cₚᵢ=xx.Enc(key, pᵢ).
   A_{I} outputs a message m′ ∈ M
The output of the above experiment is defined to be 1 if m′ ∈ {p₀, . . . , pₜ₋₁}, and 0 otherwise. Thus, it is written, wCOA^{(A}^{₀}^{,A}^{₁}⁾(κ)=1 if the output is 1 and in this case, it is said that A₁ has succeeded. The scheme xx is said to be (t, ε)-secure in the weak ciphertext-only attack (wCOA) security model for ε=negl(κ) if for all PPT algorithms A=(A₀, A₁), the following is obtained:

Prob[wCOA^{(A}^{₀}^{,A}^{₁}⁾(κ)=1]≤ε.

Octonions

In certain embodiments, octonion may be the largest among the four normed division algebras: real numbers [symbol] , complex numbers [symbol] , quaternions [symbol] , and octonions [symbol] . The real numbers may have a complete order while the complex numbers may not be ordered. The quaternions also may not be commutative, and the octonions may neither be commutative nor associative.

In mathematics, a vector space commonly refers to a finite dimensional module over the real number field [symbol] . An algebra A may refer to a vector space that is equipped with a multiplication map x:A²→A and a nonzero unit 1 ∈ A such that 1×a=a×1=a. The multiplication a×b may usually be abbreviated as a·b or ab. An algebra A may be a division algebra if, for any a, b ∈ A, ab=0 implies either a=0 or b=0. Equivalently, A may be a division algebra if and only if the operations of left and right multiplication by any nonzero element are invertible. A normed division algebra may be an algebra that is also a normed vector space with ∥ab∥=∥a∥∥b∥.

According to certain embodiments, an algebra may be power-associative if the sub-algebra generated by any single element is associative and an algebra is alternative if the sub-algebra generated by any two elements is associative. Further, if the sub-algebra generated by any three elements is associative, then the algebra itself is associative. Artin's theorem states that an algebra is alternative if and only if for all a, b ∈ A, we have

(aa)b=a(ab), (ab)a=a(ba), (ba)a=b(aa).

It is well known that [symbol] , [symbol] , [symbol] , [symbol] are the only normed division algebras and [symbol] is an alternative division algebra. It is also known that division algebras can only have dimension 1, 2, 4, or 8.

In certain embodiments, when using the same approach of interpreting a complex number a+bi as a pair [a, b] of real numbers, quaternions [symbol] (respectively, octonions [symbol] ) can be constructed from C (respectively, from H) using the Cayley-Dickson construction formula [a, b] where a, b E C (respectively, a, b E H). The addition and multiplication are defined as follows.

[a,b]+[c,d]=[a+c,b+d], [a,b][c,d]=[ac−db*, a*d+cb] (2)

where a, b, c, d ∈ [symbol] (respectively, a, b, c, d ∈ [symbol] ) and a* is the conjugate of a. Specifically, the conjugate of a real number a is defined as a*=a, and the conjugate of a complex number or a quaternion number [a, b] is defined by [a, b]*=[a*, −b]. Herein, the following notations for real and imaginary part of an octonion a ∈ [symbol] will be used,

Re(a)=(a−a*)/2 ∈ [symbol] , Im(a)=(a−a*)/2.

To check that for a complex number (or a quaternion or an octonion), there is the following:

[a,b][a,b]*=[a,b]*[a,b]=∥[a,b]∥²[1,0].

Thus all of [symbol] , [symbol] , [symbol] , and [symbol] may be division algebras (that is, each non-zero element may be a multiplicative inverse). Though Cayley-Dickson construction may provide a nice approach to study normed division algebras systematically, according to certain embodiments, it may be more intuitive to use vectors in [symbol] ⁴ to denote quaternion numbers and vectors in [symbol] ⁸ to denote octonion numbers.

Each octonion number may be a vector a=[a₀, . . . , a₇] ∈ [symbol] ⁸. The norm of an octonion a=[a₀, . . . , a₇] may be defined as ∥a∥=\sqrt{a₀²+ . . . +a₇²}. By the inductive Cayley-Dickson construction, the conjugate of an octonion a is a* =[a₀, −a₁, . . . , −a₇], and the inverse is a⁻¹ =a*/∥a∥². For each octonion number a=a₀, . . . , a₇], let a=[a₁, . . . , a₇] and

$${B}_{a} = ( \begin{matrix}{a}_{0} & {a}_{4} & {a}_{7} & - {a}_{2} & {a}_{6} & - {a}_{5} & - {a}_{3} \\ - {a}_{4} & {a}_{0} & {a}_{5} & {a}_{1} & - {a}_{3} & {a}_{7} & - {a}_{6} \\ - {a}_{7} & - {a}_{5} & {a}_{0} & {a}_{6} & {a}_{2} & - {a}_{4} & {a}_{1} \\ {a}_{2} & - {a}_{1} & - {a}_{6} & {a}_{0} & {a}_{7} & {a}_{3} & - {a}_{5} \\ - {a}_{6} & {a}_{3} & - {a}_{2} & - {a}_{7} & {a}_{0} & {a}_{1} & {a}_{4} \\ {a}_{5} & - {a}_{7} & {a}_{4} & - {a}_{3} & - {a}_{1} & {a}_{0} & {a}_{2} \\ {a}_{3} & {a}_{6} & - {a}_{1} & {a}_{5} & - {a}_{4} & - {a}_{2} & {a}_{0}\end{matrix} ) .$$

Using the matrix Bₐ, two associated 8×8 matrices may be defined as:

$${A}_{a}^{l} = ( \begin{matrix}{a}_{0} & α \\ - {α}^{T} & {B}_{a}\end{matrix} ) and {A}_{a}^{r} = ( \begin{matrix}{a}_{0} & α \\ - {α}^{T} & {B}_{a}^{T}\end{matrix} ) \qquad ( 3 )$$

According to certain embodiments, for two octonions a=[a₀, . . . , a₇] and b=[b₀, . . . , b₇], it may be possible to add them as a+b=[a₀+b₀, . . . , a₇+b₇] and multiply them as ab=bAₐ^{l}=aA_{b}^{r}. The following may also be noted:

$${A}_{{a}^{- 1}}^{l} = \frac{1}{{‖ a ‖}^{2}} ( \begin{matrix}{a}_{0} & - α \\ {α}^{T} & {B}_{a}^{T}\end{matrix} ) and {A}_{{a}^{- 1}}^{r} = ( \begin{matrix}{a}_{0} & - α \\ {α}^{T} & {B}_{a}\end{matrix} ) \qquad ( 4 )$$

In certain embodiments, some properties of the two associate matrices may be presented. For any octonion a=[a₀, . . . , a₇], it may be straightforward to show the following:

Bₐa^{T}=Bₐ^{T}a^{T}=a₀a^{T} (5)

and

BₐBₐ=a^{T}a−∥a∥²I_{7×7}+2a₀Bₐ

Bₐ^{T}Bₐ^{T}=a^{T}a−∥a∥²I_{7×7}+2a₀Bₐ^{T}

BₐBₐ^{T}=−a^{T}a+∥a∥²I_{7×7}

Bₐ^{T}Bₐ=−a^{T}a+∥a∥²I_{7×7} (6).

Thus, the following may be obtained:

$$\begin{matrix}{A}_{a}^{l} {A}_{a}^{r} = ( \begin{matrix}{a}_{0}^{2} - {αα}^{T} & {a}_{0} α + α {B}_{a}^{T} \\ - {a}_{0} {α}^{T} - {B}_{a} {α}^{T} & - {α}^{T} α + {B}_{a}^{T}\end{matrix} ) \\ = ( \begin{matrix}{a}_{0}^{2} - {αα}^{T} & {a}_{0} α + α {B}_{a}^{T} \\ - {a}_{0} {α}^{T} - {B}_{a} {α}^{T} & - {α}^{T} α + {B}_{a}^{T} {B}_{a}\end{matrix} ) \\ = {A}_{a}^{r} {A}_{a}^{l} \\ = ( \begin{matrix}{a}_{0}^{2} - {αα}^{T} & 2 {a}_{0} α \\ - 2 {a}_{0} {α}^{T} & - {α}^{T} α + {B}_{a}^{T} {B}_{a}\end{matrix} )\end{matrix} \qquad ( 7 )$$

By substituting (6) into (7), the following may be obtained:

$$\begin{matrix}{A}_{a}^{l} {A}_{a}^{r} = {A}_{a}^{r} {A}_{a}^{l} \\ = ( \begin{matrix}2 {a}_{0}^{2} - {‖ a ‖}^{2} & 2 {a}_{0} α \\ - 2 {a}_{0} {α}^{T} & - 2 {α}^{T} α + {‖ a ‖}^{2} {I}_{7 \times 7}\end{matrix} )\end{matrix} \qquad ( 8 )$$

Similarly, the following may also be obtained:

Aₐ^{l}Aₐ^{l}=2a₀Aₐ^{l} . . . ∥a∥²I_{8×8}

Aₐ^{r}Aₐ^{r}=2a₀Aₐ^{r} . . . ∥a∥²I_{8×8} (9)

Finally, the following may be checked:

Aₐ^{l}A₁_{^{−1}}^{l}=aₐ_{^{−1}}^{l}Aₐ^{l}=Aₐ^{r}Aₐ_{^{−1}}^{r}=Aₐ_{^{−1}}^{r}Aₐ^{r}=I_{8×8}.

According to certain embodiments, Aₐ^{l}Aₐ₋₁^{r}≠I_{8×8}. In addition, according to other embodiments, the following theorems may be applied:
Theorem 2. For a ∈ [symbol] , a²=2Re(a)(a)−∥a∥² 1 where 1=[1, 0, 0, 0, 0, 0, 0, 0].
Proof The identity a*=2Re(a)1−a implies ∥a∥²=aa*=2Re(a)a−a².
Theorem 3. For all a, b ∈ [symbol] , (ab)*=b*a*.
Proof. By the fact that the octonion algebra is alternative, the following may be obtained:

(ab)(b*a*)=a(bb*)a*=∥a∥²∥b∥².

Thus (ab)⁻¹=(b*a*)/(∥a∥²∥b∥²). Since (ab)⁻¹=(ab)*/(∥ab∥²), the theorem is proved.

Octonions [symbol] ( [symbol] _{q}) Over [symbol] _{q}

In the preceding section, we briefly discussed the properties of octonions. Instead of using real numbers, one may also construct “octonions” over any field F_{q} with q=p^{m} or over any ring Z_{q} with q=pᵢ^{rI} . . . pₘ^{rm}. In this section, we discuss octonions O(Z_{q}) over Z_{q}. Generally, all theorems except division-related results for octonions hold in O(Z_{q}). It is straightforward to show that O(Z_{q}) is a normed algebra. However, it is not a division algebra. In our construction of FHE schemes, the division operation is not used.

In certain embodiments, an octonion z ∈ [symbol] ( [symbol] _{q}) may be isotropic if ∥z∥=0. By Theorem 6.26 described in Lidl and Niederreiter, Finite fields, volume 20, Cambridge University Press, 1997 (the contents of which are incorporated herein in their entirety by reference), there may be q⁷+q⁴−q³=(q⁴−1)(q³+1)+1 isotropic vectors in [symbol] _{q}⁸. A slightly modified proof of the Theorem 6.26 may be used to show that the number of isotropic vectors in [symbol] _{q}⁸ is approximately in the same order of q⁷+q⁴−q³. A subspace V of [symbol] _{q}⁸ may be called totally singular or totally isotropic if all vectors in V are isotropic.

For an odd q and even n, the number of totally isotropic subspaces of dimension k≤n/2 in [symbol] _{q}ⁿ may be given by the following formula:

$$\frac{( {q}^{n - k} - {q}^{n / 2 - k} + {q}^{n / 2} - 1 ) {\prod }_{i = 1}^{k - 1} ( {q}^{n - 2 i} - 1 )}{{\prod }_{i = 1}^{k} ( {q}^{i} - 1 )} , \qquad ( 10 )$$

and totally subspaces of dimension k>n/2 in [symbol] _{q}ⁿ do not exist. It follows that the number of dimension 4 totally isotropic subspaces of [symbol] _{q}⁸ may be given by:

2(q+1)(q²+1)(q³+1) (11)

Similar results for the number of totally isotropic subspaces of dimension k over [symbol] _{q}ⁿ may be obtained.

According to certain embodiments, a ∈ [symbol] ( [symbol] _{q}) may be a non-zero isotropic octonion. Then ∥a∥²=aa*=0. That is, a has no multiplicative inverse. It follows that [symbol] ( [symbol] _{q}) may not be a division algebra. This also shows that [symbol] ( [symbol] _{q}) is not nicely normed. Further, an algebra over [symbol] _{q} may be nicely normed if a+a* ∈ [symbol] _{q} and aa*=a*a>0 for all non-zero a ∈ [symbol] ( [symbol] _{q}). In addition, it may be straightforward that Theorem 2 holds for [symbol] ( [symbol] _{q}). As such, an alternative proof to show that Theorem 3 holds for [symbol] ( [symbol] _{q}) may also be used. Proof of Theorem 3 may not be valid for [symbol] ( [symbol] _{q}) since it uses octonion inverse properties.

The following additional theorems are provided:
Theorem 4. For all a, b ∈ [symbol] ( [symbol] _{q}), we have (ab)*=b*a*.
Theorem 5. For an isotropic octonion a ∈ [symbol] ( [symbol] _{q}), we have a²=2Re(a)(a).

The Exceptional Lie Group G₂ and its Finite Version G₂(q)

A Lie algebra g over a field [symbol] may be a vector space over [symbol] with a bilinear map (called a bracket or a commutator) [·, ·]:g×g->g with the following properties: Anti-commutativity: [y, x]=−[x, y] for all x, y ∈ [symbol] ; and Jordan identity: [[x, y], z]+[[y, z], x]+[[z, x], y]=0 for all x, y, z E ∈ [symbol] .

An example of Lie algebra may include the special linear algebra slₙ of n×n matrices of trace 0 with [x, y]=xy−yx. The Lie algebra slₙ may correspond to the Lie group SLₙ of determinant 1 matrices.

According to certain embodiments, the automorphism group G₂ of octonions [symbol] (over [symbol] ) may have dimension 14, and may be the smallest among ten families of exceptional Lie groups (G2, F4, E6, E7, E₈, ²E₆, ³D₄, ²B₂, ²G₂, and ²F₄). The corresponding Lie algebra g₂ for G₂ may be the derivations Der( [symbol] ) of the octonions [symbol] . According to certain embodiments, G₂(q) may be used to denote the finite automorphism group of octonions [symbol] ( [symbol] _{q}) According to other embodiments, G2(q) may be generally used to denote the finite automorphism group of octonions [symbol] ( [symbol] _{q}) over a finite field [symbol] _{q}. However, for the finite automorphism group, related results that may be used may hold for G₂(q) over [symbol] ( [symbol] _{q}) as well as for G₂(q) over [symbol] ( [symbol] _{q}).

According to certain embodiments, since an automorphism group must fix the identity element 1, it needs to fix its orthogonal complement (that is, the purely imaginary octonions spanned by i₁, . . . , i₇). Thus, G₂(q) may be a subgroup of the orthogonal group O(7, [symbol] _{q}) of 7×7 orthogonal matrices over [symbol] _{q}. On the other hand, given the images of two octonions a, b ∈ Im( [symbol] ( [symbol] _{q})), the image of a, b may be fixed. G₂(q) therefore, is a proper subgroup of the special orthogonal group SO(7, [symbol] _{q}) of 7×7 orthogonal matrices of determinant 1 over [symbol] _{q}.

A basic triple for octonions [symbol] ( [symbol] _{q}) is three elements e₁, e₂, e₃ of norm −1 such that

−e₁e₂=−e₂e₁, e₂e₃=−eₑe₂, and e₁e₃=−e₃e₁.

−(e₁e₂)e₃=−e₃(e₁e₂).

In these elements, e₁ may generate a sub-algebra of [symbol] ( [symbol] _{q}) that is isomorphic to [symbol] ( [symbol] _{q}), (e₁, e₂) generates a sub-algebra of [symbol] ( [symbol] _{q}) that is isomorphic to H( [symbol] _{q}), and (e₁, e₂, e₃) generates all [symbol] ( [symbol] _{q}). In other words, according to certain embodiments, given (e₁, e₂, e₃) , there may be a unique way to define the imaginary octonion units i₁, . . . , i₇. Further, given any two basic triples, there may exist a unique automorphism in G₂(q) that maps the first triple to the second triple. This observation may be interpreted as follows to determine the size of G₂(q). In order to construct an automorphism in G₂(q), in certain embodiments, e₁ may be mapped to any point e′₁ on the 6-sphere of unit imaginary octonions, then maps e₂ to any point e′₂ on the 5-sphere of unit imaginary octonions that are orthogonal to e′₁, and finally maps e₃ to any point e′₃ on the 3-sphere of unit imaginary octonions that are orthogonal to e′₁, e′₂, and e′₁e′₂. By counting the number of such kind of triples, one can show that |G₂(q)|=q⁶ (q⁶−1)(q²−1).

Fully Homomorphic Encryption Scheme OctoM

Fully Homomorphic Encryption (FHE) scheme is one of the most important candidate techniques enabling privacy-preserving computation on encrypted ciphertext without decryption. Existing FHE schemes are not noise-free, and they use a somewhat-homomorphic encryption scheme. Further, these somewhat-homomorphic encryption schemes require bootstrapping techniques to convert them to fully homomorphic encryption schemes.

The main performance bottleneck for these existing FHE schemes is the “noise” reduction process, since the homomorphic operations increase the noise in ciphertexts. After a homomorphic operation (e.g., a circuit gate evaluation) is performed on the cipher-texts, a bootstrapping technique is used to refresh the ciphertexts by homomorphically computing the decryption function and bringing the noise of the ciphertexts back to acceptable levels. The bootstrapping operation accounts for the major performance cost in FHE implementations. Thus, the performance of FHE schemes can be significantly improved if one could design noise-free FHE schemes.

For example, an efficient implementation of existing FHE schemes takes approximately 4 minutes to carry out a garbled AES encryption on a 128 bit input in the cloud. According to certain embodiments, there is proposed a noise-free FHE scheme OctoM that does not require bootstrapping techniques. Thus, the implementation is very efficient. Using the same example of AES encryption, it only takes a few seconds for OctoM to carry out a garbled AES encryption on a 128 bit input in the cloud (compared with 4 minutes for existing FHE schemes).

Another advantage of FHE according to certain embodiments is that data can be encrypted offline without knowing the computation that needs to be done on the data. Such encrypted data can be worked on multiple times to do any type of computations. This is to be contrasted to other techniques that enable performing a specific computation on encrypted data (e.g., Garbled Circuits). Therefore, the type of computation that needs to be done on the encrypted data does not need to be known a priori. Moreover, using FHE, the computation on encrypted data can be performed without any communication at computation time between the client (who encrypted the data) and the server (who is performing a generic computation).

According to certain embodiments, an efficient noise-free symmetric key FHE scheme may be introduced as OctoM. In certain embodiments, the scheme OctoM is secure in the weak ciphertext-only security model. A totally isotropic subspace V ∈ [symbol] _{q}⁸ is said to be closed under octonion multiplications if for any a, b ∈ V, both ab and ba where ab and ba are the octonion multiplications (based on the definition, such kind of subspaces may be called “totally isotropic ideal subspaces”). By Theorem 5, for any isotropic vector z ∈ [symbol] _{q}⁸, z²=2Re(z)z may be obtained. Thus, for any nonzero isotropic vector z ∈ [symbol] _{q}⁸, span(z) is a dimension one totally isotropic subspace that is closed under octonion multiplications. By formulas (10) and (11), there exist dimension 3 and 4 totally isotropic subspaces for octonions [symbol] _{q}⁸. Further, there is no dimension d≥5 totally isotropic subspace for octonions [symbol] _{q}⁸.

In certain embodiments, a totally isotropic subspace V of dimension d may be uniquely determined by d isotropic octonions. For the construction of FHE scheme OctoM, it may be sufficient to have a dimension one totally isotropic subspace that is closed under octonion multiplications. In the following, the FHE protocol using the parameter q=p₁p₂ is presented. The protocol may be implemented over any finite rings [symbol] _{q} with q=p₁^{rI} . . . pₘ^{rm} and m≥3.

According to an embodiment, in a key setup, a number q=p₁p₂ may be selected according to the security parameter κ, where p₁p₂ are prime numbers. A totally isotropic subspace V ⊂ [symbol] _{q}⁸ may be selected that is closed under octonion multiplications, where V is closed under octonion multiplications. In addition, a random ϕ ∈G₂(q) and a random invertible 8×8 matrix K ∈ [symbol] _{q}^{8×8} may be selected. The private key is (K, ϕ, V) and the system parameter is Z_{q}.

According to other embodiments, for encryption, for a message m∈Z, random r∈Z_{q} and z∈V may be selected such that |A_{m′}^{l}|=0, where m′=ϕ (mi+z) and A_{m′}^{l} is the associated matrix for the octonion number m′. Note that such kind of r and z could be chosen in constant rounds since the probability for |A_{m′}^{l}|=0 converges to a uniform limit. The ciphertext therefore may be as follows:

Cₘ=OctoM.Enc(key,m)=K⁻¹A_{m′}^{l}K ∈ [symbol] _{q}^{8×8}.

In decryption, for a ciphertext Cₘ, decryption of the plaintext m may be as follows:

OctoM.Dec(keyCₘ)=ϕ⁻¹(1(KCₘK⁻¹)) mod V mod q₀.

Here, it is noted that 1(KCₘK⁻¹)=1A_{m′}=m′.

In other embodiments, in ciphertext addition, the addition of ciphertexts Cₘ₀ and Cₘ₁, may be defined as the regular component wise matrix addition Cₘ₀₊ₘ₁=Cₘ₀+Cₘ₁. Further, in ciphertext multiplication, the multiplication of ciphertexts Cₘ₀ and Cₘ₁ may be defined as the regular matrix multiplication Cₘ₀ₘ₁=Cₘ₀Cₘ₁=K⁻¹A_{m1′}¹KK⁻¹Aₘ₀¹K=K⁻¹A_{m1′}¹Aₘ₀¹K. The above encryption scheme may be identified as additive homomorphic. The multiplication homomorphic property follows from the following equations:

$$\begin{matrix}OctoM , Dec ( key , {C}_{{m}_{0} {m}_{1}} ) = {φ}^{- 1} ( 1 ( {A}_{{m}_{1}^{′}}^{i} {A}_{{m}_{0}^{′}}^{i} ) ) mod V mod {q}_{0} \\ = {φ}^{- 1} ( {m}_{0}^{′} ( {m}_{1}^{′} 1 ) ) mod V mod {q}_{0} \\ = {φ}^{- 1} ( {m}_{0}^{′} {m}_{1}^{′} 1 ) mod V mod {q}_{0} \\ = {φ}^{- 1} ( φ ( {m}_{0} 1 + {r}_{0} {q}_{0} 1 + {z}_{0} ) φ \\ ( {m}_{1} 1 + {r}_{1} {q}_{0} 1 + {z}_{1} ) ) mod V mod {q}_{0} \\ = ( {m}_{0} 1 + {r}_{0} {q}_{0} 1 + {z}_{0} ) \\ ( {m}_{1} 1 + {r}_{1} {q}_{0} 1 + {z}_{1} ) mod V mod {q}_{0} \\ = ( {m}_{0} + {r}_{0} {q}_{0} ) ( {m}_{1} + {r}_{1} {q}_{0} ) 1 mod {q}_{0} \\ = {m}_{0} {m}_{1} 1.\end{matrix}$$

According to certain embodiments, the decryption process of OctoM may be weakly equivalent to the decryption process IPE.Dec of a dimension 64 IPE scheme. For instance key=(K, ϕ, V) may be the secret key of the encryption scheme OctoM. Further, β=[b₁1, b₂, . . . , b₇] ∈ [symbol] _{q}⁸ may be a vector that is orthogonal to ϕ(V). Then, ϕ(mi+z) β=mi. For a ciphertext Cₘ, vec(Cₘ) may be the vectorization of Cₘ. Further, the decryption process OctoM.Dec(key,Cₘ) may be reformulated as the following:

$$\begin{matrix}m + {rq}_{0} = φ ( ( m + {rq}_{0} ) 1 + z ) {β}^{T} \\ = ( 1 {KC}_{m} {K}^{- 1} ) {β}^{T} \\ = [ {\sum }_{i , j = 0}^{7} {a}_{0 , i , j} {c}_{i , j} , … , {\sum }_{i , j = 0}^{7} {a}_{7 , i , j} {c}_{i , j} ] {β}^{T} \\ = {\sum }_{i , j = 0}^{7} {k}_{i , j} {c}_{i , j} \\ = k \cdot vec ( {C}_{m} ) \\ = IPE . Dec ( k , vec ( {C}_{m} ) )\end{matrix} \\ for {a}_{0 , i , j} , … , {a}_{7 , i , j} ∈ {ℤ}_{q} and \\ k = [ {k}_{0 , 0} , … , {k}_{0 , 7} , … , {k}_{7 , 7} ] ∈ {ℤ}_{q}^{64} . \qquad ( 12 )$$

FHE Over Other Algebras such as Jordan Algebra

The preceding sections propose a fully homomorphic encryption scheme based on octonion algebra. One may wonder whether it is possible to use other normed finite algebras corresponding to [symbol] , [symbol] , [symbol] , etc. to design FHE schemes. There may be only one norm preserving automorphism (identity map) for [symbol] . There may be two norm preserving automorphisms (the identity map and the dual map) for [symbol] . In addition to these two automorphisms for [symbol] , there may be infinitely many “wild” automorphisms for the complex number [symbol] . For [symbol] , in certain embodiments, the norm preserving automorphism is the group of real-linear transformations of Im( [symbol] ) preserving the cross product

$$a \times b = \frac{1}{2} ( ab - ba ) .$$

Thus the automorphism group for [symbol] is just the special orthogonal group SO(3). That is, the group of 3×3 orthogonal matrices of determinant 1.

The corresponding finite algebras for the four division algebras are [symbol] _{q}, [symbol] ( [symbol] _{q}), [symbol] ( [symbol] _{q}), and [symbol] ( [symbol] _{q}). For [symbol] _{q} with q=p^{m}, and there are exactly m Frobenius automorphisms for [symbol] _{q} which are given by φ^{k}: x [symbol] x^{pk} for 0≤k<m. It should be noted that all Frobenius automorphism fixes elements in [symbol] _{q}. For [symbol] ( [symbol] _{q}), the automorphisms could be obtained by combining the Frobenius automorphism and the dual automorphism. The automorphism group for [symbol] ( [symbol] _{q}) could be obtained by combining the Frobenius automorphism and the special orthogonal group SO(3, [symbol] _{q}). Based on these facts, it is straightforward to check that it is insecure to use automorphism groups of [symbol] _{q} and [symbol] ( [symbol] _{q}) to design fully homomorphic encryption schemes

In order to use the automorphism group for [symbol] ( [symbol] _{q}) to design fully homomorphic encryption schemes, it is necessary to guarantee that the size of the automorphism group SO(3) for [symbol] ( [symbol] _{q}), the number of isotropic vectors in [symbol] _{q}⁴, and the number of totally isotropic dimension 2 subspaces of [symbol] _{q}⁴ are sufficiently large. By Theorem 6.26 of Lidl and Niederreiter, there are q³+q(q−1)η(−1) isotropic vectors in [symbol] _{q}⁴, where η is the quadratic character of [symbol] _{q}. That is, η(−1)=1 if there is x ∈ [symbol] _{q} such that x²=−1. Otherwise, η(−1)=1. By (9), the number of totally isotropic dimensions 2 subspaces of [symbol] _{q}⁴ is 2(q+1). In certain embodiments, these arguments may be revised to show that the number of isotropic vectors in [symbol] _{q}⁴ and the number of totally isotropic dimension 2 subspaces of [symbol] _{q}⁴ are large enough for the design of an FHE scheme QuatM over [symbol] ( [symbol] _{q}) in the same way that OctoM is designed.

The security analysis for QuatM may be the same as that for OctoM. In particular, for t ciphertexts, an approach may be used to construct a quadratic equation system of 16t equations in 16+2t unknown variables. In certain embodiments, such an approach may include decrypting a ciphertext Cₘ with the following: OctoJordan.Dec(sk, Cₘ)=1×ϕ⁻¹(1(KCₘK⁻¹))1^{T}. Similarly, the security of QuatM may depend on the hardness of solving multivariate quadratic equations in [symbol] _{q} and the hardness of solving high degree univariate polynomial equations in [symbol] _{q}. Similar to the scheme OctoM, it can be shown that the scheme QuatM is weakly equivalent to the inner product encryption scheme IPE of dimension 16. Since quaternion multiplication is associative, for the design of QuatM, one may also choose the private matrix K ∈ [symbol] ( [symbol] _{q})^{4×4}. Thus the ciphertext is a matrix in [symbol] ( [symbol] _{q})^{4×4} also. Consequently, the revised QuatM is weakly equivalent to the inner product encryption scheme IPE of dimension 64.

One may also use other Lie groups to design fully homomorphic encryption schemes. For example, in certain embodiments, one may use the second smallest exceptional Lie group F₄ which is the automorphism group for the exceptional Jordan algebra (or Alberta algebra) [symbol] ₃( [symbol] ) over [symbol] . Specifically, [symbol] ₃( [symbol] ) consists of the following 3×3 Hermitian matrices (matrices that are equal to their own conjugate transposes):

$$( a , b , c , a , b , c ) = [ \begin{matrix}a & b & c \\ {c}^{*} & b & a \\ {b}^{*} & {a}^{*} & c\end{matrix} ]$$

where a, b, c ∈ [symbol] and a, b, c ∈ [symbol] and the Jordan product o is defined by

$$α ∘ β = \frac{1}{2} ( α β + β α )$$

for α, β ∈ [symbol] ₃( [symbol] ). It is straightforward that Jordan algebra is of 27-dimension over [symbol] . The Lie algebra [symbol] ₄ of F₄ is isomorphic to [symbol] ( [symbol] ) ⊕ [symbol] ³.

For the finite exceptional Jordan algebra [symbol] ₃( [symbol] ( [symbol] _{q})), the 52-dimension F₄(q)=Aut( [symbol] ₃( [symbol] ( [symbol] _{q}))) is the automorphism group of algebra [symbol] ₃( [symbol] ( [symbol] _{q})) which is a collection of the Hermitian 3×3 matrices restricted to [symbol] ( [symbol] _{q}). It can be shown that

|F₄(q)|=q²⁴(q¹²−1)(q⁸−1)(q⁶−1)(q²−1)) and G₂(q)⊂F₄(q).

The determinant of a matrix in [symbol] ₃( [symbol] ( [symbol] _{q})) is defined by

det(a, b, c, a, b, c)=abc−(a∥a∥²+b∥b∥²+c∥c∥²)+2Re(abc)

This can be expressed as

$$det ( x ) = \frac{1}{3} tr ( {x}^{3} ) - \frac{1}{2} tr ( {x}^{2} ) tr ( x ) + \frac{1}{6} {tr ( x )}^{3}$$

for x ∈ [symbol] ₃( [symbol] ( [symbol] _{q})). Thus the determinant of a Jordan algebra matrix is invariant under all automorphism F₄(q) of [symbol] ₃( [symbol] ( [symbol] _{q})). That is, for all ϕ ∈ F₄(q), we have det(x)=det(ϕ(x)). In the following, we first describe the protocol for the FHE scheme JordanM.

In a Key Setup q=p₁p₂ may be selected according to the given security parameter κ. Randomly select isotropic vectors z₁, z₂, z₃ ∈ [symbol] ( [symbol] _{q}) satisfying the following identity

z₂−z*₁=z₃ and Re(z₁z₂z₃)≠0 (12)

Note that such kind of z₁, z₂, z₃ could be obtained by solving an equation system of 11 equations (eight obtained from (16) and three obtained from the identity ∥z₁∥=∥z₂∥=∥z₃∥=0) in 24 variables. Let ϕ ∈ F₄(q) be a randomly selected automorphism and let K ∈ [symbol] _{q}^{3×3} be a randomly selected 3×3 nonsingular matrix. The private key is key=(ϕ, K, z₁, z₂, z₃).

In an Encryption for a message m ∈ [symbol] _{q}, random r₁, r₂, r₃, r₄, r₅ r ∈ [symbol] _{q} may be chosen such that det(Eₘ)≠0, where Em is the Hermitian matrix Eₘ=(m, r₄,r₅,r₁z₁,r₂z₂,r₃z₃). Let the ciphertext Cₘ=JordanM.Enc(key, m) K⁻¹ ϕ (Eₘ)K.

In a Decryption for a received ciphertext Cₘ, the plaintext may be decrypted as m=JordanM.Dec(key, Cₘ)=1 ϕ⁻¹(KCₘK⁻¹)1^{T}.

In Ciphertext addition, the addition of two ciphertexts Cₘ_{₀} and Cₘ_{₁} may be defined as the regular component wise matrix addition Cₘ_{₀}₊ₘ_{₁}=Cₘ_{₀}+Cₘ_{₁}.

In Ciphertext multiplication, the multiplication of two ciphertexts Cₘ_{₀} and Cₘ_{₁} may be defined as the Jordan product o:

$$\begin{matrix}{C}_{{m}_{0} {m}_{1}} = {C}_{{m}_{1}} ∘ {C}_{{m}_{0}} \\ = ( {K}^{- 1} φ ( {E}_{{m}_{0}} ) φ ( {E}_{{m}_{1}} ) K + {K}^{- 1} φ ( {E}_{{m}_{1}} ) φ ( {E}_{{m}_{0}} ) K ) \text{/} 2 \\ = {K}^{- 1} ( ( φ ( {E}_{{m}_{0}} ) φ ( {E}_{{m}_{1}} ) + φ ( {E}_{{m}_{1}} ) φ ( {E}_{{m}_{0}} ) ) \text{/} 2 ) K \\ = {K}^{- 1} φ ( {E}_{{m}_{0}} ∘ {E}_{{m}_{1}} ) K .\end{matrix}$$

In the encryption process JordanM.Enc, the random numbers may be chosen in such a way that det(Eₘ)≠0 no matter whether m=0 or not. By the identity (16), z₂z*₁=z₃ is obtained. This implies that z₃z₁=0 and z*₃z₂=0. By these arguments and by the identity (ab)*=b*a* from Theorem 4, the multiplication homomorphism of JordanM could be verified straightforwardly and the details are omitted due to space limit.

In the key setup process JordanM.KeySetup, it is sufficient to use ϕ ∈ F₄(q) that are represented by the primitive idempotents A ∈ [symbol] ₃ ( [symbol] ( [symbol] _{q})) with A o A=A and tr(A)=1. That is, ϕ is defined by

ϕ: B [symbol] B+4tr(A o B)A−4B o A

It is further noted that the primitive idempotents in the Jordan algebra are exactly the elements (a, b, c, a, b, c) satisfying

a+b+c=1

a²+∥b∥²+∥c∥²=a

b*a=cc*

and the equations obtained from these by cycling a, b, c and a, b, c.

It should be noted that, for any (a, b, c, a, b, c) ∈ [symbol] ₃( [symbol] ( [symbol] _{q})), there exists ϕ ∈ F₄(q) such that ϕ ((a, b, c, a, b, c)) is diagonalized (see, e.g., Baez, The octonions, Bullet, American Mathematical Society, 39(2): 145-205, 2002; the entire contents of which are incorporated herein by reference). The security analysis for JordanM is similar to that of OctoM and we have the following theorem (proof is omitted due to space limit).

In Theorem 5, assuming that it is computationally infeasible to solve univariate polynomial equation systems of degree larger than 2, it is computationally infeasible to solve multivariate/univariate quadratic equation systems in [symbol] _{q}, and the plaintext messages are uniformly distributed over [symbol] _{q}_{₀}. Then the encryption scheme JordanM over [symbol] _{q} is (t, negl(K))-secure in the weak ciphertext-only security model for any t≤poly(κ).

In the scheme JordanM, the private key K is chosen as a 3×3 matrix over [symbol] _{q}. If K were chosen as a 3×3 matrix over [symbol] ( [symbol] _{q}), then the scheme would not be multiplicative homomorphic since octonion multiplication is not associative. However, one may use Jordan algebra restricted to quaternions [symbol] ( [symbol] _{q}) to design an FHE scheme JordanQuaterM. Then one can use a 3×3 matrix K ∈ [symbol] ( [symbol] _{q})^{3×3} as the private key since quaternion multiplication is associative. Furthermore, one may also use high dimension Hermitian matrices for the design of JordanM scheme. For example, one may use the n-dimension Hermitian matrices design JordanM.

Privacy Preserving Garbled Computation in Cloud

The efficient FHE schemes designed herein may be expected to have a wide range of applications. For instance, according to certain embodiments, several applications may pertain to privacy preserving garbled computation in the cloud. As one example, an owner may have software (e.g., with a slow but feasible secret algorithm to break the commonly used public key encryption scheme RSA (a public key encryption scheme that were designed by Ron Rivest, Adi Shamir and Leonard Adleman in 1977) when powerful computing resources are available), and the cloud may have a powerful computing resource. The software owner may want to run his software in the cloud but he does not want to leak his secret algorithm. The cloud therefore, may provide computing resources to the software owner, and it does not need to learn the software output.

According to certain embodiments, the actual protocol may function in the following exemplary manner: the software owner may upload his re-usable obfuscated software to the cloud. The obfuscation of the re-usable software may be achieved by treating the software like input data and encrypting the re-usable software using the OctoM encryption scheme. Thus the cloud does not know what kind of software it is. Each time when the software owner wants to run the obfuscated software in the cloud, he may provide obfuscated inputs to the cloud. The obfuscation of the input may be achieved by encrypting the input using the OctoM encryption scheme. In other words, the cloud does not know what the input data is. The cloud may then use a universal circuit (or a universal Turing machine) to run the obfuscated re-usable software on the obfuscated inputs.

Since both the inputs and the software may be encrypted using the same fully homomorphic encryption scheme OctoM, by running the universal circuit on both encrypted software and encrypted input, the cloud may obtain an encrypted output. Since the cloud does not have the OctoM secret key, the cloud cannot decrypt this encrypted output and learns nothing about the output value. The cloud returns this encrypted output to the software owner. The software owner can now use the secret key to decrypt the encrypted output to get the actual output. As mentioned in preceding paragraphs, the OctoM scheme does not require bootstrapping. Thus, the cloud server could run the universal circuit on the obfuscated software and obfuscated input very efficiently (e.g., just a few seconds for homomorphic AES decryption). On the other hand, if existing FHE scheme are used for the encryption of software and input, it may take several days for the cloud to run the universal circuit on the obfuscated software and inputs. It is noted that the cloud server may only have access to OctoM encrypted software and inputs, nothing else. Thus, the cloud server may learn zero information about the software or the input.

Straight Line Programs, Arithmetic Circuits, and Universal Circuits

Arithmetic circuits have been used as a model for computing polynomials. An arithmetic circuit may take either variables or numbers as inputs. The only allowed gates in an arithmetic circuits are additions and multiplications. For the Boolean circuit model, it uses AND, OR, and NOT gates. Since these gates could be redesigned using NAND gates, it may be assumed that all circuits contain NAND gates only. Each NAND gate may be converted to two arithmetic gates using the formula “x NAND y=1−xy”. Thus, each Boolean circuit may be converted to an arithmetic circuit that computes the same function. By the above discussion, each Boolean circuit may be converted to a straight line program where a straight-line program is a sequence of operations that only uses additions and multiplications as follows.

$$Input \text{:} {x}_{0} , … , {x}_{n - 1}$$

$${v}_{0} = {w}_{0 , 0} ∘ p {w}_{0 , 1}$$

$$…$$

$${v}_{i - 1} = {w}_{i - 1 ,} ∘ p {w}_{i - 1 , 1}$$

where v₀, . . . , vₜ₋₁ are temporary variables. Each operator op is either + or ×, and the variables w_{i,0}, w_{i,1} are either constants within {1, −1} or variables from the list x₀, . . . , xₙ₋₁, v₀, . . . , vₜ₋₁.

For a universal straight line program U, it may take an input (C, x) where C is an encoded straight line program and U(C, x)=C(x). When a universal straight line program U (alternatively, a universal arithmetic circuit or a universal circuit) is used, the structure of U may become public knowledge, and there is no need to protect the control flow within U. It is sufficient to protect the input privacy (that is, both C and x). It should be noted that this is also sufficient for the protection of keyed programs, where the obfuscation does not depend on hiding the entire structure of the obfuscated program from the adversary and it only hides a short secret key embedded in the program.

Protocol for Garbled Computation in Cloud

According to certain embodiments, for the garbled computation in the cloud mentioned above, the cloud may not need to know the software output. Thus, an efficient FHE scheme together with a universal straight line program may be sufficient for this kind of software obfuscation. In the obfuscation approach according to certain embodiments, one may only need to homomorphically encrypt all input variables (that is, both C and x, where C is the private circuit that the software owner wants to protect). That is, each variable xᵢ may be homomorphically encrypted to cᵢ=FHE.Enc(key, xᵢ). Each operator can then be evaluated homomorphically as c=FHE.Eval(c₁,c₂;op)).

In certain embodiments, U may be a universal straight line program and C may be the straight line program that the software owner wants to obfuscate. Then, according to certain embodiments, the protocol may proceed as follows: the software owner may construct reusable garbled software as Ç=FHE.Enc(key,C), and upload Ç to the cloud; for each evaluation, the software owner may provide the encrypted input FHE.Enc(key,x) to the cloud; the cloud may run the universal straight line program U on (Ç, FHE.Enc(key,x)) to obtain the encrypted output

FHE.Enc(key,C(x))=FHE.Eval(C,FHE.Enc(key,x); U);

and the software owner may decrypt the actual output:

C(x)=FHE.Dec(key,FHE.Enc(key,C(x))).

Practical Considerations—Dictionary Attacks

As discussed above, FHE schemes OctoM, QuatM, JordanM may be secure in the wCOA security mode. Furthermore, it has been shown above that known plaintext-ciphertext pairs of these FHE schemes may lead to the complete recovery of the private key. This may give the adversary the possibility of carrying out an exhaustive search based dictionary attacks in case that the guessable message space is small. As an example, it may be assumed that for given ciphertexts c₁, . . . , cₜ of the scheme OctoM, one can obtain 64 independent ciphertext vectors from c₁, . . . , cₜ using the fully homomorphic property. If the corresponding message mₗ, . . . , mₜ∈M for some |M|<N, then the adversary may do an exhaustive search of Al to obtain the candidate key space of size N. Furthermore, if the adversary can guess that some ciphertexts correspond to the same plaintext, then the adversary can use the additive homomorphism operations to obtain a valid ciphertext for the message 0. Based on these observations, an implementation of the FHE schemes according to certain embodiments should take these factors into consideration. In particular, if possible, an appropriate message padding scheme may be applied before the FHE encryption process is used. These padding schemes may be compatible with the homomorphic operations.

Practical Considerations—Bits of Security

According to certain embodiments, the security of the FHE schemes OctoM, QuatM, JordanM may depend on the hardness of solving multivariate quadratic equations and univariate high degree polynomial equations within [symbol] _{q}. The hardness of these problems may more or less be related to the hardness of factoring q. For example, the problem of solving quadratic equations in [symbol] _{q} is equivalent to the problem of factoring q. According to certain embodiments, it is recommended to use q=p₁p₂. In other embodiments, the ring sizes for [symbol] _{q} in the following Table 1 may be used.

TABLE 1
Bits of Security and [symbol] _{q}

| Bits of Security | 80 | 112 | 128 | 192 | 256 |
|---|---|---|---|---|---|
| q = p₁p₂ in bits [3] | 102 | 204 | 307 | 768 | 1536 |
| q = p₁p₂p₃ in bits | 153 | 233 | 307 | 768 | 1536 |
| q = p₁p₂p₃p₄ in bits | 204 | 307 | 456 | 768 | 1536 |

Table 2, lists the number of ring multiplications for the FHE schemes of certain embodiments. For the performance comparison, the number of ring multiplications needed for the RSA encryption scheme is included. In the table, it may be assumed that the RSA public key is 3, and the private key size is the same as the modulus length. Furthermore, it may be assume that the RSA private key contains around 50% ones and the “square-and-multiply” algorithm is used for the RSA decryption process. From Table 2, it is observed that both the schemes OctoM and QuatM are more efficient than the RSA decryption process for all parameters. For the scheme JordanM, if the automorphism is implemented as a regular Jordan product, then it requires 1734 multiplications at most. Thus, the total number of multiplications for a JordanM.Enc or JordanM.Dec is 2127, and both JordanM encryption and decryption processes may be more efficient than the RSA decryption process for the security strength of 128-bits or more. However, if special automorphism ϕ were chosen and ϕ were implemented more efficiently than the RSA decryption process, then both JordanM encryption and decryption processes may be more efficient than the RSA decryption process for all parameters.

TABLE 2
Performance comparison in terms of field multiplication

| | OctoM | QuatM | JordanM | RSA |
|---|---|---|---|---|
| Encryption | 1026 | 130 | 393 + 1734 = 2127 | 3 |
| Decryption | 578 | 82 | 393 + 1734 = 2127 | 1.5\|q\| |
| Homo Multi. | 512 | 64 | 3456 | |

In view of the above, ciphertext expansion factors for schemes OctoM, QuatM, and JordanM may be pointed out. The ciphertext expansion factor for a scheme xx may be defined as max{|cₘ|/|m|}, where cₘ=xx.Enc(key,m) is the ciphertext of m. For the scheme OctoM (respectively QuatM and JordanM), the ciphertext cₘ for m∈ [symbol] _{q0} may be a collection of 64 elements from [symbol] _{q}. Thus, the message expansion factors for the schemes OctoM, QuatM, and Jordan M may be 128, 32, and 144, respectively.

Proof of Security

With the above-described OctoM scheme, security of the weak ciphertext-only (wCOA) security model may be shown. According to certain embodiments, this assumes that the only attack one could mount on OctoM is to guess the IPE decryption key via ciphertexts only without using the homomorphic properties, and without using other algebraic attacks. Since the decryption process of OctoM may be weakly equivalent to IPE.Dec, it may be sufficient for the adversary to recover the inner product decryption secret k. However, the probability for one to recover the IPE.Dec secret k from the IPE ciphertexts may only be negligible

The preceding section shows that the decryption process of the scheme OctoM is equivalent to the decryption process of the dimension 64 IPE. Thus the scheme OctoM is not secure against adversaries who have access to sufficiently many linearly independent ciphertexts with known plaintexts. Furthermore, OctoM is not secure in the ciphertext only attack (COA) security model. In the following, certain embodiments show that OctoM is secure in the weak ciphertext-only (wCOA) security model.

In certain embodiments, OctoM is shown to be secure in the wCOA model assuming that the only attack one could mount on OctoM is to guess the IPE decryption key via ciphertexts only without using the homomorphic properties and without using other algebraic attacks. Since the decryption process of OctoM is equivalent to IPE.Dec, it is sufficient for the adversary to recover the inner product decryption secret k. Though it may be a folklore that the probability for one to recover the IPE.Dec secret k from IPE ciphertexts only is negligible (without limit on the number of ciphertexts), there is no literature reference for this. For completeness, the following proof for this “folklore” is provided.
Theorem 6. Let κ be the security parameter, n<t<poly(κ), and assume that the plaintext messages are uniformly distributed over [symbol] _{q}. Given t ciphertexts c₀, . . . , cₜ₋₁ ∈ [symbol] _{q}ⁿ of a dimension n encryption scheme IPE, the probability for one to guess the correct private key k∈ [symbol] _{q}ⁿ or for one to guess at least one correct plaintext for the given ciphertexts is at most 1/qⁿ. In other words, the scheme IPE is secure in wCOA.

Proof for the given t ciphertexts, one can formulate t linear equations in t+n variables m=[m₀, . . . , mₜ₋₁] and k=k₀, . . . , kₙ₋₁]: k[c₀^{T}, . . . , cₜ₋₁^{T}]=m.

Assume that the ciphertexts c₀, . . . , cₜ₋₁ are linearly independent. Then for any fixed m₀, . . . , ∈ [symbol] _{q}, the equation system has a unique solution. On the other hand, if no n ciphertexts are linearly independent, then for any fixed m₀, . . . , mₜ₋₁ ∈ [symbol] _{q}, there are more than one solutions for the equation system. In a summary, the probability that the adversary recovers the private key is less than or equal to the probability that the adversary has a correct guess of the messages m₀, . . . , mₜ₋₁ ∈ [symbol] _{q}. This probability is at most 1/qⁿ. Thus the Theorem is proved. Before proving the main theorem, a Lemma should first be proved. For a ciphertext Cₘ, Cₘ⁰ may be used to denote the identity matrix I.

Lemma. Let Cₘ=OctoM.Enc(key,m) and Cₘ², . . . , Cₘ⁸ be ciphertexts of m², . . . , m⁸ respectively. Then vec(Cₘ^{o})=vec(I), vec(Cₘ¹), . . . , vec(Cₘ⁸) are linearly dependent.

Theorem 7. Assuming that it is computationally infeasible to solve multivariate/univariate quadratic equation systems in [symbol] _{q}, and the plaintext messages are uniformly distributed over [symbol] _{q}. Then the encryption scheme OctoM over [symbol] _{q} is (t, negl(κ))-secure in the weak ciphertext-only security model for any t<poly(κ).

FIG. 1 illustrates a flow diagram according to certain embodiments. In particular, FIG. 1 illustrates a flow diagram of a user device, such as for example, but not limited to, a computer. In step 101, a user device may encrypt data with the FHE scheme described above. For example, the data may be encrypted by selecting a random r∈Z_{q} and z∈V such that |A_{m′}^{l}|=0, where m′=ϕ(mi+z) and A_{m′}^{l} is the associated matrix for the octonion number m′. Here, r and z could be chosen in constant rounds since the probability for |A_{m′}^{l}|=0 converges to a uniform limit.

In step 105, the user device may upload the encrypted data to a server. According to certain embodiments, the server may be a cloud server or a physical server. The server may provide computing resources to the owner of the data, and does not need to learn the software output. Further, each time the owner wants to run the encrypted data in the server, the owner may provide encrypted inputs to the server. For instance, at step 110, the owner, via the user device, may send the encrypted data inputs to the server. The server may then run the encrypted data, and the encrypted data may be output/returned to the owner.

In step 115, the user device may receive the encrypted data output of computation on encrypted data and input from the server, and in step 120, decrypt the encrypted output. In certain embodiments, decryption may be performed as described above with respect to the FHE scheme. In step 125, the user device may generate new encrypted input data, and repeat the process for a new computation that reuses the encrypted data.

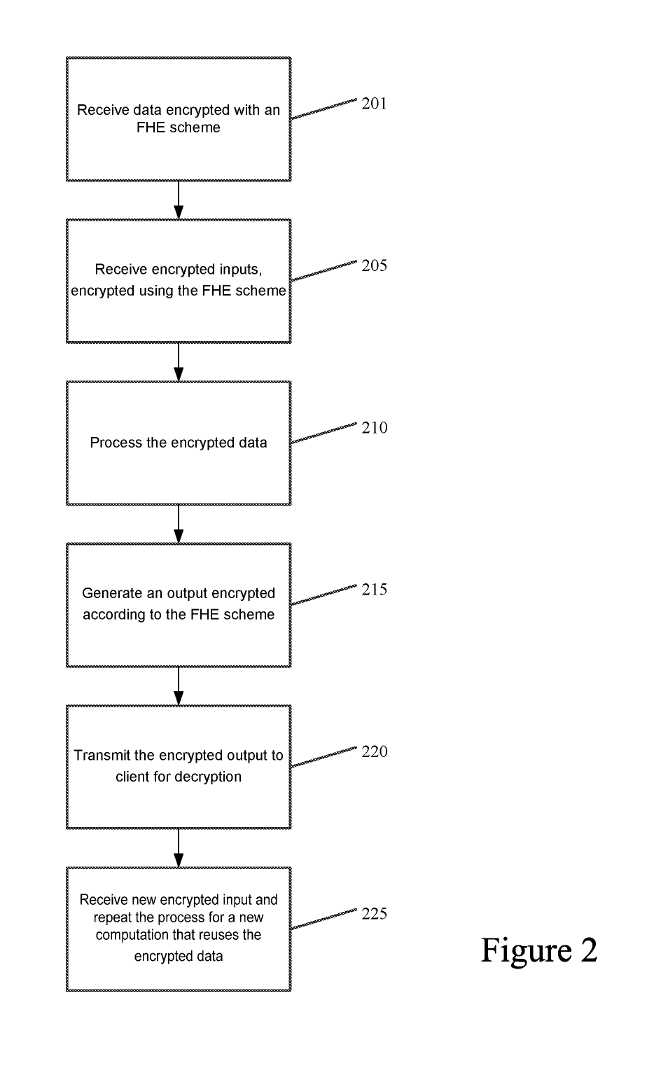

FIG. 2 illustrates another flow diagram according to certain embodiments. In particular, FIG. 2 illustrates a flow diagram of a server, such as a cloud server or a physical server. In step 201, the server may receive data encrypted with an FHE scheme. In certain embodiments, the FHE scheme may be that as described above. Along with the encrypted data, the server may, in step 205, receive encrypted inputs, encrypted using the FHE scheme. After receiving the encrypted data, in step 210, the server may process the encrypted data, and in step 215, generate an output encrypted according to the FHE scheme. The encrypted output may then, in step 220, be transmitted to a client for decryption. In step 225, the server may receive new encrypted input and repeat the process for a new computation that reuses the encrypted data.

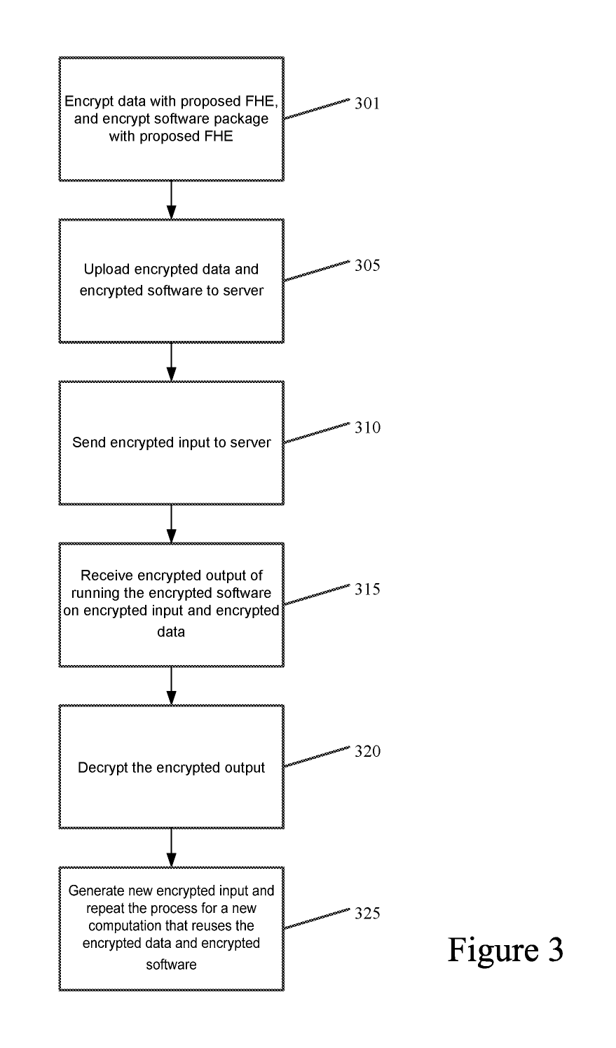

FIG. 3 illustrates yet another flow diagram according to certain embodiments. In particular, FIG. 3 illustrates a flow diagram of a user device, such as for example, but not limited to, a computer. In step 301, the user device may encrypt data with the FHE scheme described above, and encrypt a software package with the FHE scheme.

In step 305, the user device may upload the encrypted data and encrypted software to a server. The server may be a cloud server or a physical server. The server may provide computing resources to the owner of the data and software, and does not need to learn the software output. Further, each time the owner wants to run the encrypted data in the server, the owner may provide encrypted inputs to the server. For instance, in step 310, the owner, via the user device, may send the encrypted data inputs to the server. The server may then run the encrypted data and encrypted software, and the encrypted data and encrypted software may be output/returned to the owner.

At step 315, the user device may receive the encrypted data output of running the encrypted software on encrypted input and encrypted data from the server, and at step 320, decrypt the encrypted output. In certain embodiments, decryption may be performed as described above with respect to the FHE scheme. In step 125, the user device may generate new encrypted input data, and repeat the process for a new computation that reuses the encrypted data and encrypted software.

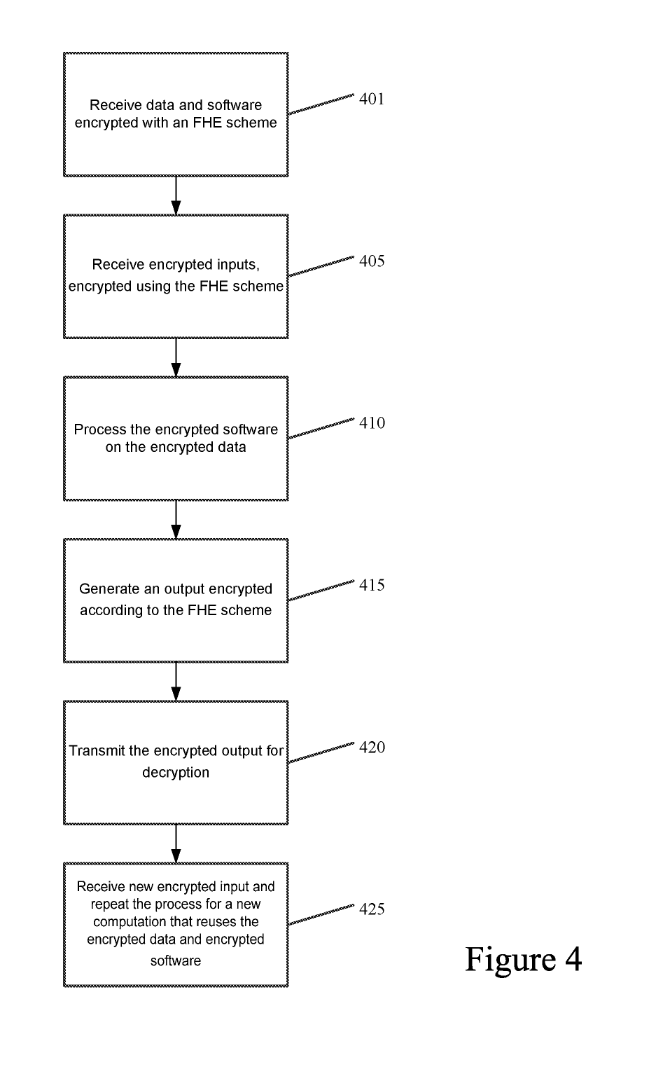

FIG. 4 illustrates another flow diagram according to certain embodiments. In particular, FIG. 4 illustrates a flow diagram of a server, such as a cloud server. In step 401, the server may receive data and software encrypted with an FHE scheme. In an embodiment, the FHE scheme may be that as described above. Along with the encrypted data and software, in step 405, the server may receive encrypted inputs, encrypted using the FHE scheme. After receiving the encrypted inputs and software, in step 410, the server may process the encrypted data, and in step 415, generate an output encrypted according to the FHE scheme. The encrypted output may then, in step 420, be transmitted to a client for decryption. In step 425, the server may receive new encrypted input and repeat the process for a new computation that reuses the encrypted data and encrypted software.

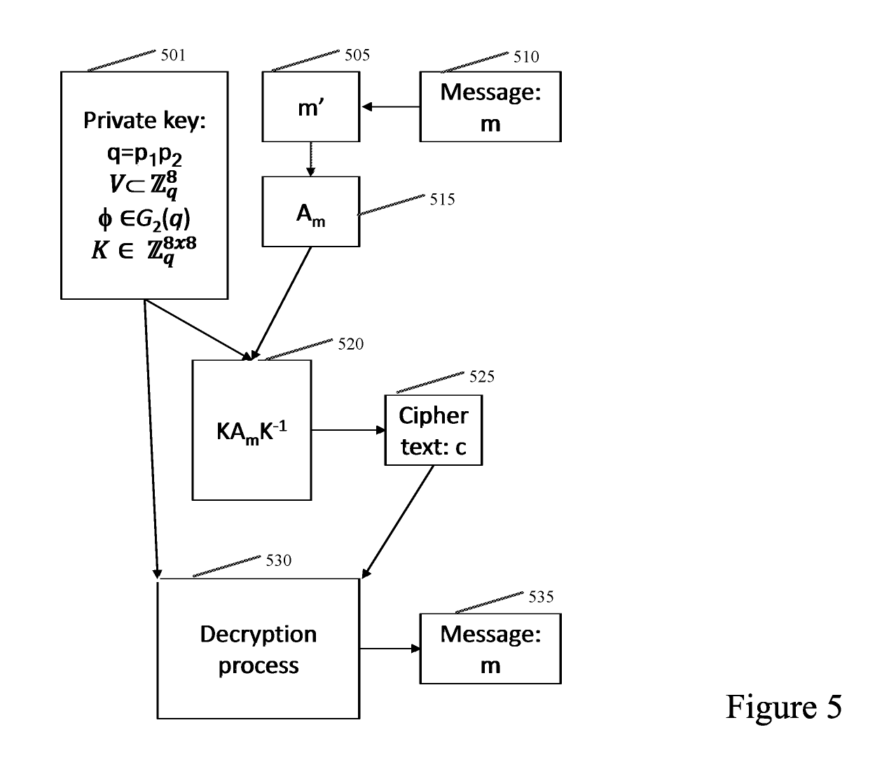

FIG. 5 illustrates a further flow diagram according to certain embodiments. In particular, FIG. 5 illustrates a flow diagram of an OctoM encryption and decryption processes. In step 501, the owner may generate the OctoM private key (K, ϕ, V). In step 510, the owner may select a message m. The message m may be converted to m′ in step 505 which may further be converted to a matrix Aₘ in step 515. In step 520, the secret key K may be used to encrypt the message matrix Aₘ to obtain the ciphertext in step 525. In step 530, the secret key may be used to decrypt the ciphertext to obtain the message m in step 535.

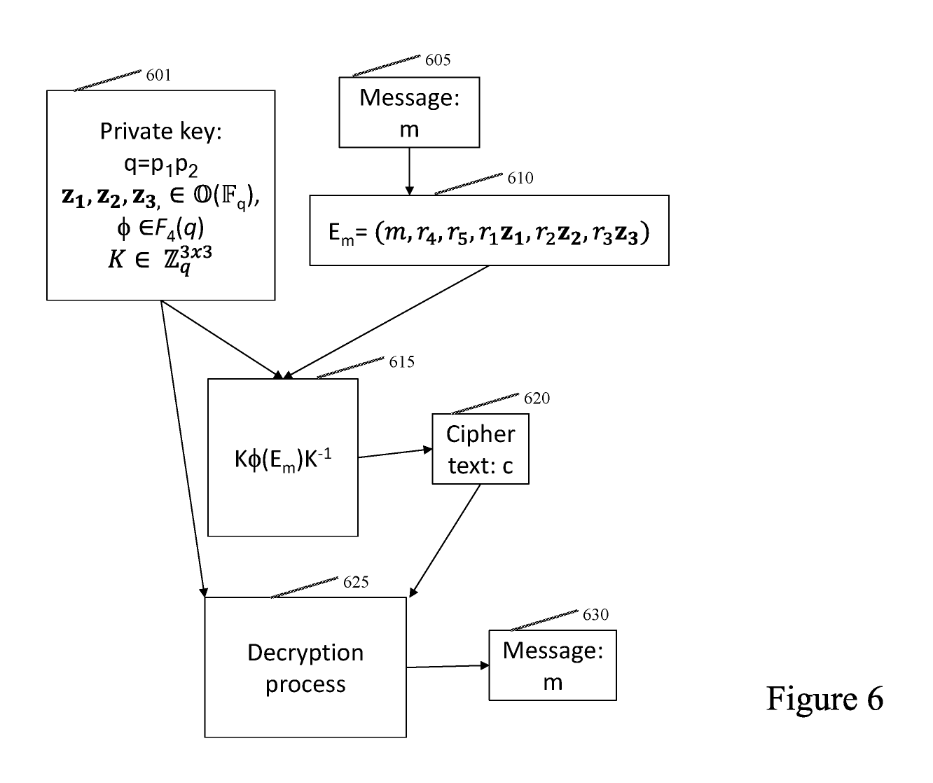

FIG. 6 illustrates another flow diagram according to certain embodiments. In particular, FIG. 6 illustrates a flow diagram of a JordanM encryption and decryption processes. In step 601, the owner may generate the JordanM private key (ϕ, K, z₁, z₂, z₃). In step 605, the owner may select a message m. The message m may be converted to an encoded version Eₘ in step 610. In step 615, the secret key (ϕ, K, z₁, z₂, z₃) may be used to encrypt the message Eₘ to obtain the ciphertext in step 620. In step 625, the secret key may be used to decrypt the ciphertext to obtain the message m in step 630.

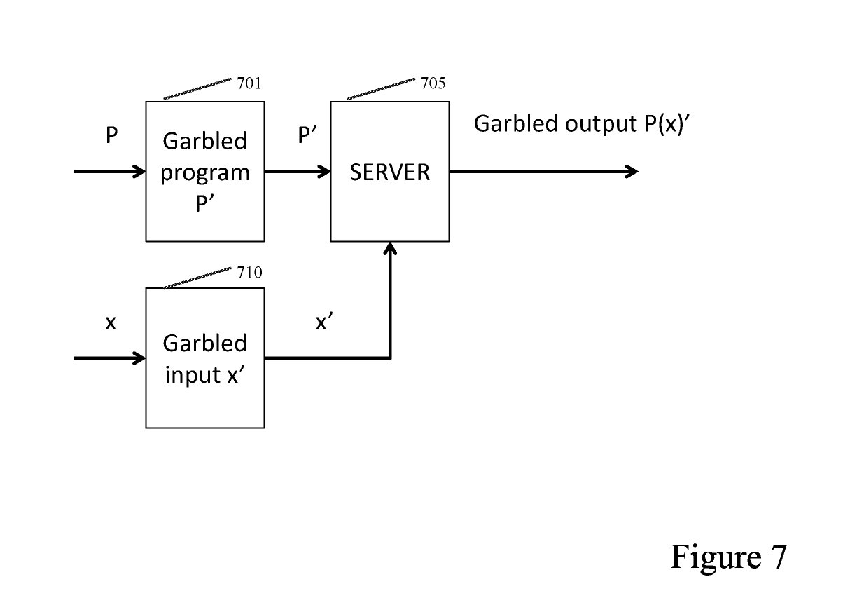

FIG. 7 illustrates a further flow diagram according to certain embodiments. In particular, FIG. 7 illustrates a flow diagram for the server to run a universal circuit on an obfuscated program and an obfuscated input. In step 701, the software owner may use the encryption scheme OctoM to encrypt the program P to obtain the encrypted/obfuscated version P′. In step 710, the software owner may use the encryption scheme OctoM to encrypt the input x to obtained the encrypted/obfuscated version x′. In step 705, both the obfuscated program P′ and obfuscated input x′ may be given to the server. In step 705, the server may run the universal circuit on the obfuscated program P′ and obfuscated input x′ to obtain a garbled output P(x)′.

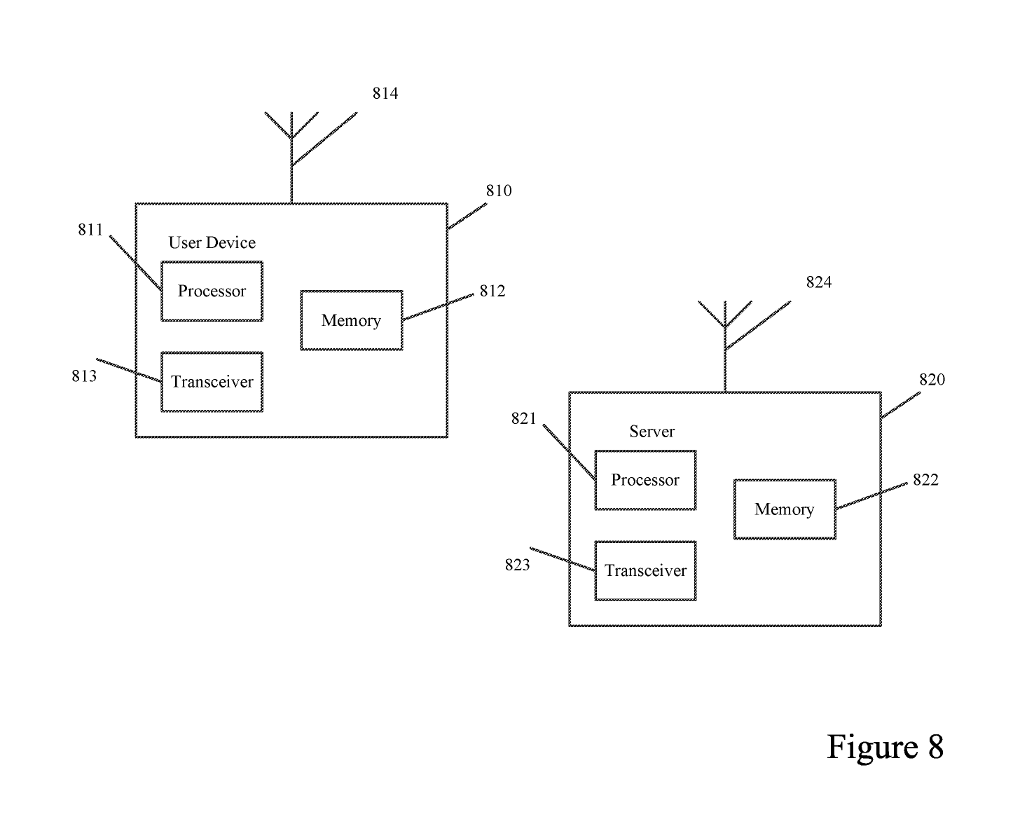

FIG. 8 illustrates a system according to certain embodiments. It should be understood that each signal or block in FIGS. 1-7 and 9 may be implemented by various means or their combinations, such as hardware, software, firmware, one or more processors and/or circuitry. In one embodiment, a system may include several devices, such as, for example, a user device 810 and a server 820. The system may include more than one user device 810 and more than one server 820, although only one of each of these devices are shown for the purposes of illustration.

The user device 810 and server 820 may each include at least one processor 811 and 821. At least one memory may be provided in each device, and indicated as 812 and 822, respectively. The memory may include computer program instructions or computer code contained therein. One or more transceivers 813 and 823 may be provided, and each device may also include an antenna, respectively illustrated as 814 and 824. Although only one antenna each is shown, many antennas and multiple antenna elements may be provided to each of the devices. Other configurations of these devices, for example, may be provided. For example, user device 810 and server 820 may be additionally configured for wired communication, in addition to wireless communication, and in such a case antennas 814 and 824 may illustrate any form of communication hardware, without being limited to merely an antenna.

Transceivers 813 and 823 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or severs, in a flexible manner. In other words, division of labor may vary case by case. One or more functionalities may also be implemented as virtual application(s) in software that can run on a server.

A user device 810 may be a mobile station (MS) such as a mobile phone or smart phone or multimedia device, a computer, such as a tablet, laptop computer or desktop computer, provided with wireless communication capabilities, personal data or digital assistant (PDA) provided with wireless communication capabilities. In other embodiments, the user device may be replaced with a machine communication device that does not require any human interaction, such as a sensor, meter, or robot.

In some embodiments, an apparatus, such the user device 810 or server 820, may include means for carrying out embodiments described above in relation to FIGS. 1-7 and 9. In certain embodiments, at least one memory including computer program code can be configured to, with the at least one processor, cause the apparatus at least to perform any of the processes described herein and shown in the figures.

Processors 811 and 821 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 812 and 822 may independently be any suitable storage device such as those described above. The memory and the computer program instructions may be configured, with the processor for the particular device, to cause a hardware apparatus such as user device 810 or server 820, to perform any of the processes described above (see, for example, FIGS. 1-7 and 9). Therefore, in certain embodiments, a non-transitory computer-readable medium may be encoded with computer instructions or one or more computer program (such as added or updated software routine, applet or macro) that, when executed in hardware, may perform a process such as one of the processes described herein. Alternatively, certain embodiments may be performed entirely in hardware.

According to certain embodiments therefore, it may be possible to provide and/or achieve various advantageous effects and improvements in computer technology. For instance, according to certain embodiments, it may be possible to introduce efficient noise-free FHE schemes in the weak ciphertext-only security model. Further, the proposed schemes described above may be used to solve a specific type of problem for privacy preserving garbled cloud computation. There may also be a wide range of applications for the above-described FHE schemes, according to certain embodiments.

According to other embodiments, it may be possible to provide efficient and practical methods for FHE symmetric key encryption. Such methods may be based on quaternion/octonion algebra and Jordan algebra over finite rings [symbol] _{q}. Methods, according to certain embodiments, may be faster than conventional schemes because they do not require bootstrapping. Certain embodiments also offer a noise-free FHE method, as opposed to conventional FHE techniques that add noise and require a slow process known as “bootstrapping”. According to further embodiments, methods may be secure in the weak ciphertext-only security model assuming the hardness of solving multivariate quadratic equation systems, and solving univariate high degree polynomial equation systems in [symbol] _{q}. Further, certain embodiments may be sufficient for privacy preserving garbled computation in the cloud.

In certain embodiments, it may further be possible to provide a system and process for encoding private data and private data software so that they could be hosted and stored in a cloud server, which is not trusted by the client. The techniques, according to certain embodiments, may be designed in such a way that the client could upload both software and data to an untrusted cloud server. The user may later submit encoded inputs to the cloud server, which would run the program over the user inputs and the encoded data stored at the cloud server. Further, the cloud server may carry out both passive and active attacks in an effort to learn private information contained in the data. However, with the techniques described according to certain embodiments, the untrusted server will learn zero information about the user data or the user program structure.

Although the foregoing description is directed to the preferred embodiments of the invention, it is noted that other variation and modifications will be apparent to those skilled in the art, and may be made without departing from the spirit or scope of the invention. Moreover, features described in connection with one embodiment of the invention may be used in conjunction with other embodiments, even if not explicitly stated above.

We claim:

1. A method, comprising:
generating a secret key,
wherein generating the secret key comprises:
selecting a number according to a security parameter, wherein the number is a product of two prime numbers;
selecting an isotropic subspace from a tuple of eight numbers smaller than the number selected according to the security parameter, wherein the isotropic substance is closed under octonion multiplications;
selecting a random automorphism from a collection of automorphisms and a random invertible 8×8 matrix, wherein the random invertible 8×8 matrix is selected from a collection of matrices whose elements are smaller than the number selected according to the security parameter; and
setting a private key as a combination of the isotropic subspace, the random automorphism, and the random invertible 8×8 matrix.

2. The method of claim 1, further comprising:
encrypting data with the secret key,
wherein encrypting the data comprises:
selecting a random number from a collection of numbers smaller than the number selected according to the security parameter;
selecting a random point, wherein the random point is an element of the isotropic subspace;
adding the random point to an octonion (0,m,0,0,0,0,0,0), wherein m is the data to be encrypted to obtain an octonion
using the random automorphism to map the octonion m₁ to another octonion m′;
calculating an associate matrix A_{m′}¹ for the octonion m′; and
obtaining the encrypted data by multiplying together an inverse of the random invertible 8×8 matrix, the random invertible 8×8 matrix, and A_{m′}¹.

3. The method of claim 2, further comprising:
decrypting the encrypted data,
wherein decrypting the encrypted data comprises multiplying together a first row of a matrix obtained by multiplying the random invertible 8×8 matrix, the encrypted data, and the inverse of the random invertible 8×8 matrix, with an inverse of the random automorphism.

4. The method of claim 2, further comprising:
uploading the encrypted data to a server,
wherein encrypting the data comprises encrypting an input,
wherein the method further comprises sending the encrypted input to the server,
wherein the server is configured to run a public software on the encrypted input and the encrypted data, and obtain an encrypted output, and
wherein the method further comprises
receiving the encrypted output from the server, and
decrypting the encrypted output by multiplying together a first row of a matrix obtained by multiplying the random invertible 8×8 matrix, the encrypted data, and the inverse of the random invertible 8×8 matrix, with an inverse of the random automorphism.

5. The method of claim 2,
wherein the encrypting data comprises encrypting a program,
wherein the method further comprises uploading the encrypted data and the encrypted program to a server,
wherein the encrypting data comprises encrypting an input,
wherein the method further comprises sending the encrypted input to the server,
wherein the server is configured to run the encrypted program on the encrypted input and the encrypted data,
wherein the server is configured to obtain an encrypted output, and
wherein the method further comprises
receiving the encrypted output from the server, and
decrypting the encrypted output by multiplying together a first row of a matrix obtained by multiplying the random invertible 8×8 matrix, the encrypted data, and the inverse of the random invertible 8×8 matrix, with an inverse of the random automorphism.

6. An apparatus, comprising:
at least one memory comprising computer program code; and
at least one processor;
wherein the at least one memory and the computer program code are configured, with the at least one processor, to cause the apparatus at least to:
generate a secret key,
wherein generation of the secret key comprises:
selecting a number according to a security parameter, wherein the number is a product of two prime numbers;
selecting an isotropic subspace from a tuple of eight numbers smaller than the number selected according to the security parameter, wherein the isotropic substance is closed under octonion multiplications;
selecting a random automorphism from a collection of automorphisms and a random invertible 8×8 matrix, wherein the random invertible 8×8 matrix is selected from a collection of matrices whose elements are smaller than the number selected according to the security parameter; and
setting a private key as a combination of the isotropic subspace, the random automorphism, and the random invertible 8×8 matrix.

7. The apparatus of claim 6, wherein the at least one memory and the computer program code are further configured, with the at least one processor, to cause the apparatus at least to encrypt data with the secret key,
wherein encrypting the data comprises:
selecting a random number from a collection of numbers smaller than the number selected according to the security parameter;
selecting a random point, wherein the random point is an element of the isotropic subspace;
adding the random point to an octonion (0,m,0,0,0,0,0,0), wherein m is the data to be encrypted to obtain an octonion
using the random automorphism to map the octonion m₁ to another octonion m′;
calculating an associate matrix A_{m′}¹ for the octonion m′; and
obtaining the encrypted data by multiplying together an inverse of the random invertible 8×8 matrix, the random invertible 8×8 matrix, and A_{m′}¹.

8. The apparatus of claim 7, wherein the at least one memory and the computer program code are further configured, with the at least one processor, to cause the apparatus at least to decrypt the encrypted data,
wherein decrypting the encrypted data comprises multiplying together a first row of a matrix obtained by multiplying the random invertible 8×8 matrix, the encrypted data, and the inverse of the random invertible 8×8 matrix, with an inverse of the random automorphism

9. The apparatus of claim 7, wherein the at least one memory and the computer program code are further configured, with the at least one processor, to cause the apparatus at least to upload the encrypted data to a server,
wherein encrypting data comprises encrypting an input,
wherein the at least one memory and the computer program code are further configured, with the at least one processor, to cause the apparatus at least to send the encrypted input to the server,
wherein the server is configured to run a public software on the encrypted input and the encrypted data, and obtain an encrypted output, and
wherein the at least one memory and the computer program code are further configured, with the at least one processor, to cause the apparatus at least to
receive the encrypted output from the server, and
decrypt the encrypted output by multiplying together a first row of a matrix obtained by multiplying the random invertible 8×8 matrix, the encrypted data, and the inverse of the random invertible 8×8 matrix, with an inverse of the random automorphism.

10. The apparatus of claim 7,
wherein the encrypting data comprises encrypting a program,
wherein the at least one memory and the computer program code are further configured, with the at least one processor, to cause the apparatus at least to upload the encrypted data and the encrypted program to a server,
wherein encrypting the data comprises encrypting an input,
wherein the at least one memory and the computer program code are further configured, with the at least one processor, to cause the apparatus at least to send the encrypted input to a server,
wherein the server is configured to run the encrypted program on the encrypted input and the encrypted data,
wherein the server is configured to obtain an encrypted output, and
wherein the at least one memory and the computer program code are further configured, with the at least one processor, to cause the apparatus at least to
receive the encrypted output from the server, and
cause the apparatus at least to decrypt the encrypted output by multiplying together a first row of a matrix obtained by multiplying the random invertible 8×8 matrix, the encrypted data, and the inverse of the random invertible 8×8 matrix, with an inverse of the random automorphism.

11. A computer program, embodied on a non-transitory computer readable medium, the computer program, when executed by a processor, causes the processor to:
generate a secret key,
wherein generation of the secret key comprises:
selecting a number according to a security parameter, wherein the number is a product of two prime numbers;
selecting an isotropic subspace from a tuple of eight numbers smaller than the number selected according to the security parameter, wherein the isotropic substance is closed under octonion multiplications;
selecting a random automorphism from a collection of automorphisms and a random invertible 8×8 matrix, wherein the random invertible 8×8 matrix is selected from a collection of matrices whose elements are smaller than the number selected according to the security parameter; and
setting a private key as a combination of the isotropic subspace, the random automorphism, and the random invertible 8×8 matrix.

12. The computer program of claim 11, wherein the computer program, when executed by the processor, further causes the processor to encrypt data with the secret key,
wherein encrypting the data comprises:
selecting a random number from a collection of numbers smaller than the number selected according to the security parameter;
selecting a random point, wherein the random point is an element of the isotropic subspace;
adding the random point to an octonion (0,m,0,0,0,0,0,0), wherein m is the data to be encrypted to obtain an octonion m₁;
using the random automorphism to map the octonion m₁ to another octonion m′;
calculating an associate matrix A_{m′}¹ for the octonion m′; and
obtaining the encrypted data by multiplying together an inverse of the random invertible 8×8 matrix, the random invertible 8×8 matrix, and A_{m′}¹.

13. The computer program of claim 12, wherein the computer program, when executed by the processor, further causes the processor to decrypt the encrypted data,
wherein decrypting the encrypted data comprises multiplying together a first row of a matrix obtained by multiplying the random invertible 8×8 matrix, the encrypted data, and the inverse of the random invertible 8×8 matrix, with an inverse of the random automorphism.

14. The computer program of claim 12, wherein the computer program, when executed by the processor, further causes the processor to upload the encrypted data to a server,
wherein encrypting the data comprises encrypting an input,
wherein the at least one memory and the computer program code are further configured, with the at least one processor, to cause the apparatus at least to send the encrypted input to the server,
wherein the server is configured to run a public software on the encrypted input and the encrypted data, and obtain an encrypted output, and
wherein the at least one memory and the computer program code are further configured, with the at least one processor, to cause the apparatus at least to
receive the encrypted output from the server, and
decrypt the encrypted output by multiplying together a first row of a matrix obtained by multiplying the random invertible 8×8 matrix, the encrypted data, and the inverse of the random invertible 8×8 matrix, with an inverse of the random automorphism.

15. The computer program of claim 12,
wherein the encrypting data comprises encrypting a program,
wherein the computer program, when executed by the processor, further causes the processor to upload the encrypted data and the encrypted program to a server,
wherein the encrypting data comprises encrypting an input,
wherein the computer program, when executed by the processor, further causes the processor to send the encrypted input to a server,
wherein the server is configured to run the encrypted program on the encrypted input and the encrypted data,
wherein the server is configured to obtain an encrypted output, and
wherein the computer program, when executed by the processor, further causes the processor to
receive the encrypted output from the server, and
decrypt the encrypted output by multiplying together a first row of a matrix obtained by multiplying the random invertible 8×8 matrix, the encrypted data, and the inverse of the random invertible 8×8 matrix, with an inverse of the random automorphism.
